(19) United States
(12) Patent Application Publication
(10) Pub. No.: US 2006/0078277 A1
(43) Pub. Date: Apr. 13, 2006

(54) Broadcast receiving apparatus and network connection method

(76) Inventor: Koji Miyazaki, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/231,779

(22) Filed: Sep. 22, 2005

(30) Foreign Application Priority Data
Sep. 24, 2004 (JP) 2004-277995

(51) Int. Cl. H04N 5/76

(52) U.S. Cl. 386/46; 386/125

(57) ABSTRACT

A broadcast receiver to be connected through a network is provided, wherein management of files or folders on shared digital recording equipment is performed safely when a plurality of sets of digital recording equipment connected to the network and a plurality of broadcast receivers are connected to one another through the network. Each broadcast receiver has connecting units (terminals) to which a plurality sets of recording equipment can be connected through the network, an equipment selection control unit for selecting desired recording equipment and a recording signal control unit for supplying a recording signal to the desired recording equipment and for designating recording of the recording signal. Each broadcast receiver records identification information for a broadcast receiver main body which has output the recording signal onto management information stored in the desired recording equipment so as to manage the recording signal recorded in the desired recording equipment.

### CROSS-REFERENCE TO RELATED APPLICATIONS

This application is based upon and claims the benefit of priority from prior Japanese Patent Application No. 2004-277995, filed Sep. 24, 2004, the entire contents of which are incorporated herein by reference.

### BACKGROUND OF THE INVENTION

1. Field of the Invention

The present invention relates to improvements in a broadcast receiver and a broadcast receiving method for receiving broadcasts such as a digital television broadcast. More specifically, the invention relates to a technique capable of avoiding problems related to digital recording equipment being simultaneously accessed from different equipment and files being deleted as a result.

2. Description of the Related Art

As is well known, in recent years, acceleration of digitization of television broadcasts has been promoted. For example, in Japan, not only satellite digital broadcasting, such as broadcasting satellite (BS) digital broadcasts and 110° communication satellite (CS) digital broadcasts, but also terrestrial digital television broadcasts has been started.

It has become possible for a digital broadcast receiver for receiving such digital television broadcasts to digitally record the received program or reproduce the recorded program by connecting digital recording equipment with a large capacity such as a hard disk drive (HDD).

Nowadays, it is possible for the digital broadcast receiver to specify any digital recording equipment for recording a program and reproducing a recorded program by connecting a plurality of sets of digital recording equipment to configure a network to a single digital broadcast receiver.

Incidentally, for a broadcast receiver that enables a plurality of sets of digital recording equipment to be connected to a network, it becomes important to allow a user to easily manage programs recorded in respective digital recording equipment and to quickly retrieve the desired recorded program to be reproduced.

A configuration enabling a connection state via a telephone line to be recognized even in a state that the sound from television signals is output from a loud speaker in a television receiver having an Internet receiving function is disclosed in Jpn. Pat. Appln. KOKAI Publication No. 10-136275.

### BRIEF SUMMARY OF THE INVENTION

As described above, when a plurality of sets of digital recording equipment can be connected through a network to a digital broadcast receiver, it is necessary for respective recording equipment to be managed. Especially, when there are a plurality of sets of digital recording equipment, graphical interfaces are required to easily manage the recording equipment. When a digital broadcast receiver is enabled to be connected through a network, there is the possibility that active equipment, such as a second digital broadcast receiver, is connected to the network. In this case, there is a possibility that first and second digital broadcast receivers access the same digital recording equipment irrespective of simultaneity of their access timing. In such accesses, there is a risk for the first and the second receivers to delete files or folders, or additionally record or overwrite-record the files or folders. At this moment, though the first receiver has recorded a program A, there is a risk that the program A is deleted, or the program A is overwritten by the second receiver.

An object of the embodiments of the invention is to provide a broadcast receiver to be connected through a network, which can safely manage files and folders on shared digital recording equipment in an environment in which a plurality of sets of digital recording equipment connected to a network and a plurality of digital broadcast receivers are connected via the network.

According to one aspect of the present invention, there is provided a broadcast receiver to be connected through a network comprising: connection means for connecting a plurality of recording means via the network; equipment selection means for selecting the desired recording means among the recording means; recording signal output means for reproducing a program in a received signal to be a recording signal, supplying it to the desired recording means selected by the selection means and recording it; and means for additionally writing identification (hereinafter referred to as ID) information for a broadcast receiver main body which has output the recording signal to management information stored in the desired recording means so as to manage the recording signal recorded in the desired recording means. This broadcast receiver has means for selecting the desired recording means by the selection means, for checking the ID information in overwriting or in additional recording and for overwriting or additionally recording when the checked ID information is same as its own ID information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an embodiment of the present invention and is a view for schematically explaining a digital television broadcast receiver and an example of a network configured around the broadcast receiver as a center;

FIG. 2 is a block diagram for explaining a principal signal processing system of the broadcast receiver in the embodiment in FIG. 1;

FIG. 3 is an external view for explaining a remote controller of the broadcast receiver in the embodiment in FIG. 1;

FIG. 4 is a flowchart for explaining operations by which the broadcast receiver in the embodiment in FIG. 1 records a program into digital recording equipment;

FIG. 5 is a view for explaining an example of a program table displayed in recording operations of the broadcast receiver in the embodiment in FIG. 1;

FIG. 6 is a flowchart for explaining operations by which the broadcast receiver in the embodiment in FIG. 1 reproduces recorded programs from a digital recording equipment;

FIG. 7 is a view for explaining an example of a navigation menu displayed in reproducing operations of the broadcast receiver in the embodiment in FIG. 1;

FIG. 8 is a view for explaining a state in which items of the recorded programs are selected from the navigation menu in the embodiment in FIG. 1;

FIG. 9 is a view for explaining an example of a list display screen of recently recorded programs which can be obtained from the navigation menu in the embodiment in FIG. 1;

FIG. 10 is a view for explaining an example of a favorite program list display screen of the broadcast receiver in the embodiment in FIG. 1;

FIG. 11 is a view for explaining an example of a keyword retrieval screen of the broadcast receiver in the embodiment in FIG. 1;

FIG. 12 is a view for explaining an example of a list display screen of equipment connected to the broadcast receiver in the embodiment in FIG. 1;

FIG. 13 is a view for explaining an example of a list display screen of programs recorded by specified equipment connected to the broadcast receiver in the embodiment in FIG. 1;

FIG. 14 is a view for explaining an example of a list display screen of keyword-retrieved program among the programs recorded by the specified equipment connected to the broadcast receiver in the embodiment in FIG. 1;

FIG. 15 is a view for explaining an example of a data recording format in digital recording equipment connected to the broadcast receiver in the embodiment in FIG. 1;

FIG. 16 is a flowchart for explaining operations to set a program specified reservation to the broadcast receiver in the embodiment in FIG. 1;

FIGS. 17A, 17B and 17C are views for explaining an example of a display screen when making a reservation for a program to be recorded, by using an electronic program list;

FIG. 18 is a view showing an example of a screen appeared when the program to be recorded is specified by using the electronic program list;

FIG. 19 is a view showing an example of an equipment selection screen to select equipment to perform recording;

FIG. 20 is a view showing an another example of the equipment selection screen to select the equipment to perform the recording;

FIG. 21 is a view showing an example of a recording setting screen which is displayed when a DVD recorder to compose a LAN 3 is selected then a recording reservation button is selected in the equipment selection screen;

FIG. 22 is a view showing an another example of the recording setting screen which is displayed when a DVD recorder to compose the LAN 3 is selected and the recording reservation button is selected in the equipment selection screen;

FIG. 23 is a view showing an example of a recording setting screen when an HDD device connected as an i.LINK (trademark) 2 then the recording reservation button is selected in the equipment selection screen;

FIG. 24 is a view showing an another example of the recording setting screen when the HDD device connected as the i.LINK 2 then the recording reservation button is selected in the equipment selection screen;

FIG. 25 is a view showing an example of an aspect of the recording setting screen when the HDD device connected to the LAN 2 is selected then the recording reservation button is selected;

FIG. 26 is a view showing an example in which a plurality of recording modes TS, XP and SP are displayed along with each other; and

FIG. 27 is a flowchart showing an operation example when the recording-reserved program is recorded in the broadcast receiver in the embodiment in FIG. 1.

### DETAILED DESCRIPTION OF THE INVENTION

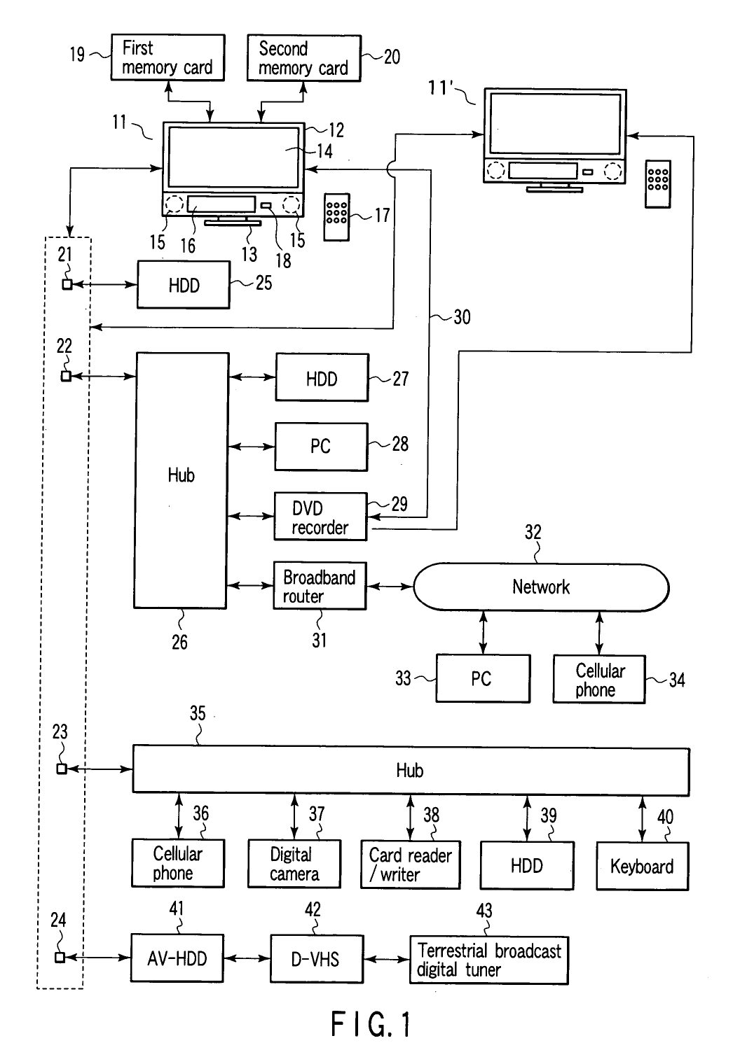

Hereinafter, embodiments of the invention will be explained by referring to the drawings. FIG. 1 schematically shows the external appearance of digital television broadcast receivers 11, 11′ which will be explained in embodiments of the invention, and an example of a network system configured around the broadcast receivers 11, 11′ as a center.

Since the broadcast receivers 11, 11′ are of the same type, hereinafter only the broadcast receiver 11 will be explained as a representative.

The broadcast receiver 11 is composed mainly of a thin cabinet 12 and a support base 13 which supports the cabinet 12. The cabinet 12 is provided with a flat panel type video display unit 14 composed of a liquid crystal display panel or the like, a loud speaker 15, an operation unit 16 and a light receiving unit (remote-controlled operation receiving unit) 18 to receive operation information transmitted from a remote controller 17.

The broadcast receiver 11 has a detachable first memory card 19, such as a secure digital (SD) memory card, a multimedia card (MMC) and a memory stick, and performs recording/reproducing of information of a program, a photograph or the like to and from the first memory card 19.

The broadcast receiver 11, further, has a detachable second memory card (IC card) 20 with, for example, contract information recorded thereon and performs recording/reproducing of information to and from the second memory card 20.

The broadcast receiver 11 is provided with a first local area network (referred to as LAN 2) terminal 21, a second LAN (referred to as LAN 2) terminal 22, a universal serial bus (USB) terminal 23 and an i.Link (trademark) terminal 24.

Among these parts, the first LAN terminal 21 is used as a LAN-compatible HDD dedicated port. The first LAN terminal 21 is connected to a LAN-compatible HDD 25 being a network attached storage (NAS). The first LAN terminal 21 is used to record/reproduce information to and from the HDD 25 through Ethernet (registered trademark).

As mentioned above, by providing the first LAN terminal 21 to be the LAN-compatible HDD dedicated port, the broadcast receiver 11 can stably performs information recording with a high image quality onto the HDD 25 without being influenced by other network environments or the status of use of the network.

The second LAN terminal 22 is used as a general LAN-compatible port using the Ethernet. The second LAN terminal 22 is connected to equipment such as a LAN-compatible HDD 27, a personal computer (PC) 28 and a digital versatile disk (DVD) recorder 29 with a built-in HDD through, for example, a hub 26 and used in information transmission between these parts and the broadcast receiver 11.

Since digital information communicated through the second LAN terminal 22 is information of a control system, the DVD recorder 29 requires a dedicated analog transmission path 30 to transmit information of analog video and sound to the broadcast receiver 11.

The second LAN terminal 22 is connected to, for example, a network 32 such as the Internet via a broadband router 31 connected to the hub 26 and used to communicate information between a PC 33 or a cellular phone 34, etc., and the broadcast receiver 11 via the network 32.

The USB terminal 23 is used as a general USB-compatible port, connected to, for example, a cellular phone 36, a digital camera 37, a card reader/writer 38 for a memory card, an HDD 39 and a keyboard 40 and used to make information transmission between the equipment and the broadcast receiver 11.

The foregoing i.Link terminal 24 serially connects an AV-HDD 41, a digital video home system (VHS) 42, etc., and establishes the information transmission between the equipment and the broadcast receiver 11.

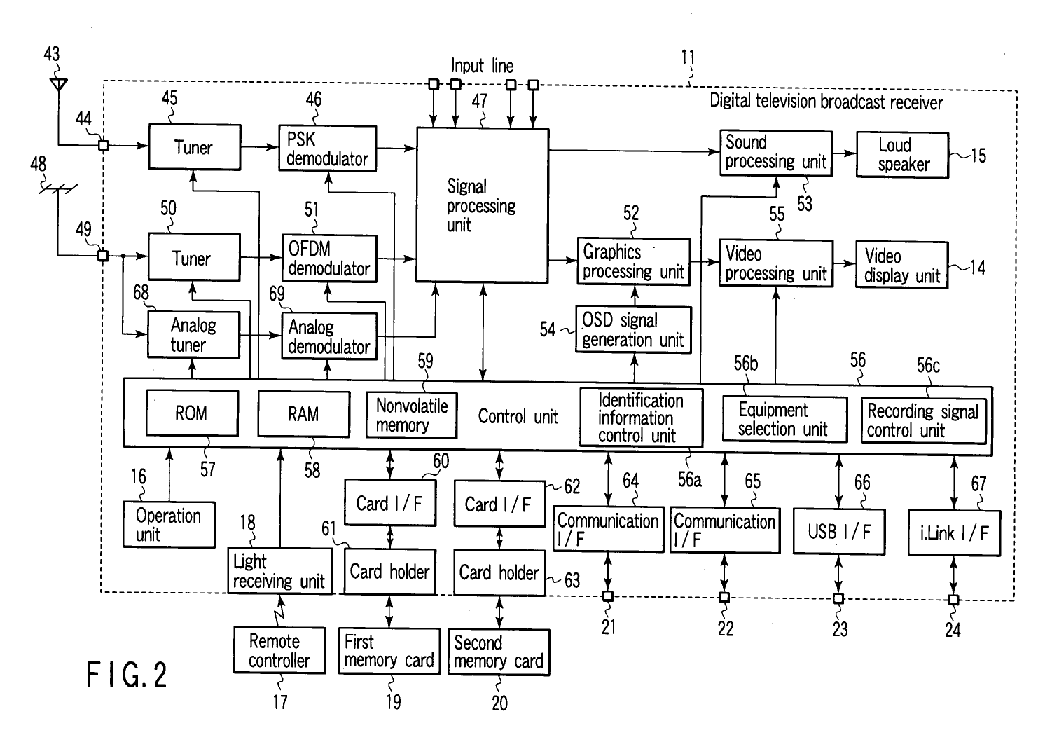

FIG. 2 shows the principal signal processing system of the foregoing broadcast receiver 11. That is, a satellite digital television broadcast signal received at an antenna 43 for receiving BS/CS digital broadcasts is supplied to a tuner 45 for satellite digital broadcasts through an input terminal 44, and the tuner 45 tunes a broadcast signal on a desired channel.

The broadcast signal tuned by the tuner 45 is fed to a phase shift keying (PSK) demodulator 46 to be demodulated to a digital video signal and a digital sound signal then output to a signal processor 47.

An analogue tuner 68 is also provided with the broadcast receiver 11. The signal received through the tuner 68 is demodulated by an analogue demodulator 69 and output to the processor 47.

A terrestrial digital television broadcast signal received at an antenna 48 for receiving terrestrial digital television broadcast is supplied to a tuner 50 for the terrestrial digital television broadcast via an input terminal 49, then, the tuner 50 tunes the broadcast signal on the desired channel.

The broadcast signal tuned by the tuner 50 is supplied to an orthogonal frequency division multiplexing (OFDM) demodulator 51 to be demodulated to a digital video signal and a digital sound signal then output to the signal processor 47.

The signal processor 47 selectively conducts prescribed digital signal processing on the digital video signals and sound signals supplied from the PSK demodulator 46 and from the OFDM demodulator 51, and on the video signals and analog signals supplied from the analog demodulator 69 and further from the line input terminals. After this signal processing, the digital processor 47 outputs an output signal to a graphic processor 52 and a sound processor 53.

Among these processors, the graphic processor 52 has a function to superimpose an on-screen display (OSD) signal generated from an OSD signal generator 54 onto the digital video signal supplied from the signal processor 47 and output the superimposed signal. The graphic processor 52 can selectively output between the video signal output from the signal processor 47 and the OSD signal output from the signal generator 54 and can combine and output both outputs so that both outputs configure a half of a screen, respectively.

The digital video signal output from the graphic processor 52 is supplied to a video processor 55. The video processor 55 converts the input digital video signal into an analog video signal in a format possible to be displayed on the video display unit 14 and outputs the analog video signal to the video display unit 14 to make a video display.

The sound processor 53 converts an analog sound signal in a format possible to be reproduced by the loud speaker 15 and outputs the analog sound signal to the loud speaker 15 to make a sound reproduction.

The broadcast receiver 11 integrally controls the overall operation, including the above-mentioned various types of receiving operations, by means of a control unit 56 incorporated therein. The control unit 56 has a built-in central processing unit (CPU), etc., receives operation information from the operation unit 16, or receives operation information transmitted from the remoter controller 17 and respectively controls each part so as to reflect operation contents thereto.

In this case, the control unit 56 mainly uses a read only memory (ROM) 57 with a control program to be executed by the CPU stored thereon, a random access memory (RAM) 58 to provide an operation area to the CPU, and a nonvolatile memory 59 to which a variety of items of setting information and control information are stored.

The control unit 56 is connected to a card holder 61 to which the first memory 19 can be attached through a card interface (I/F) 60. The control unit 56 thereby can make information transmission to the first memory card 19 attached to the card holder 61 through the card I/F 60.

The control unit 56 is further connected to a card holder 63 to which the second memory card 20 can be attached through a card I/F 62. The control unit 56 thereby can make information communication with the second memory card 20 attached to the card holder 63 through the card I/F 62.

The control unit 56 is also connected to the first LAN terminal 21 through a communication I/F 64. The control unit 56 can thereby perform information communication with the LAN-compatible HDD 25 connected to the first LAN terminal 21 through the communication I/F 64. In this case, the control unit 56 has a dynamic host configuration protocol (DHCP) server function and assigns an internet protocol (IP) address to the LAN compatible HDD 25 connected to the first LAN terminal 21 to control the HDD 25.

The control unit 56 is further connected to the second LAN terminal 22 through a communication I/F 65. The control unit 56 can thereby make information communication with each piece of equipment (refer to FIG. 1) connected to the second LAN terminal 22 through the communication I/F 65.

The control unit 56 is connected to the USB terminal 23 through an USB I/F 66. The control unit 56 can thereby perform information communication with each piece of equipment (refer to FIG. 1) connected to the USB terminal 23 through the USB I/F 66.

Furthermore, the control unit 56 is connected to the i.Link terminal 24 through an i.Link I/F 67. Thereby, the control unit 56 can make information communication with each piece of equipment (refer to FIG. 1) connected to the i.Link terminal 24 through the i.Link I/F 67.

Here, the control unit 56 is provided with ID information control unit 56a to process the ID information of a broadcast receiver main body. As explained below, the control unit 56 is also provided with an equipment selection control unit 56b and a recording signal control unit 56c. The equipment control unit 56b can select the recording equipment in accordance with user operations. The recording signal control unit 56c conducts control to transmit a signal to be recorded into the selected recording equipment. The recording signal control unit 56c also determines whether or not the user can perform overwrite recording and additional recording onto the recording medium. The ID information control unit 56a manages ID information of the recording equipments and this broadcast receiver 11.

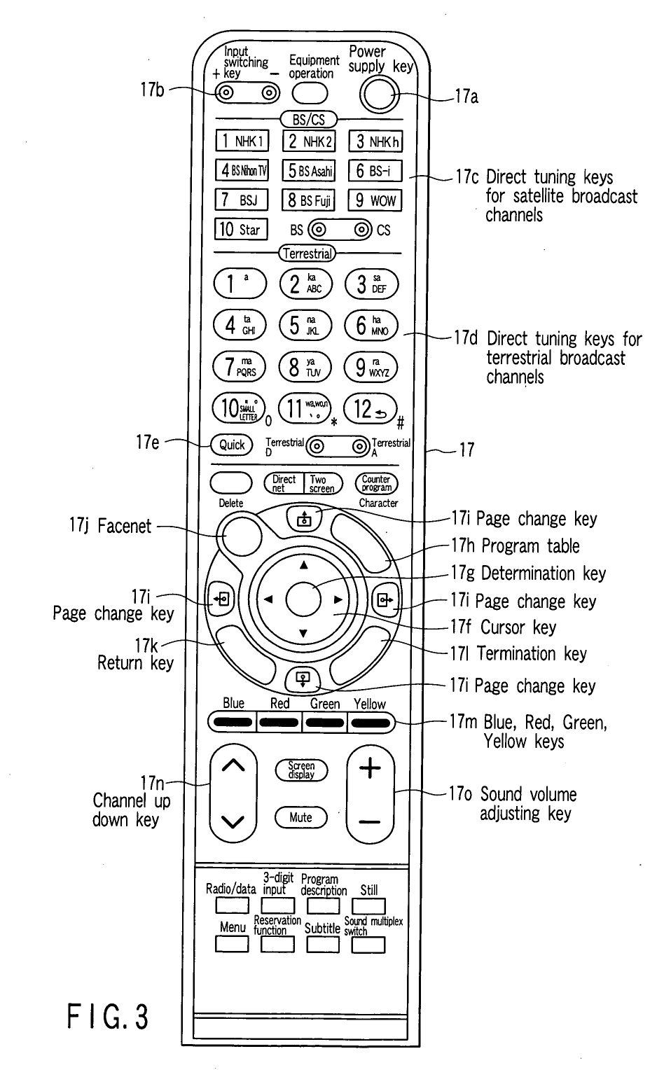

FIG. 3 shows an external view of the remote controller 17. The remote controller 17 mainly comprises a power supply key 17a, input switching keys 17b, direct tuning keys for satellite broadcast channels 17c, direct tuning keys for terrestrial broadcast channels 17d, a quick key 17e, a cursor key 17f, a determination key 17g, a program table key 17h, page switching keys 17i, a facenet (trademark) (navigation) key 17j, a return key 17k, a termination key 17l, color keys in blue, red, green, and yellow 17m, a channel up down key 17n, a sound volume adjusting key 17o, etc.

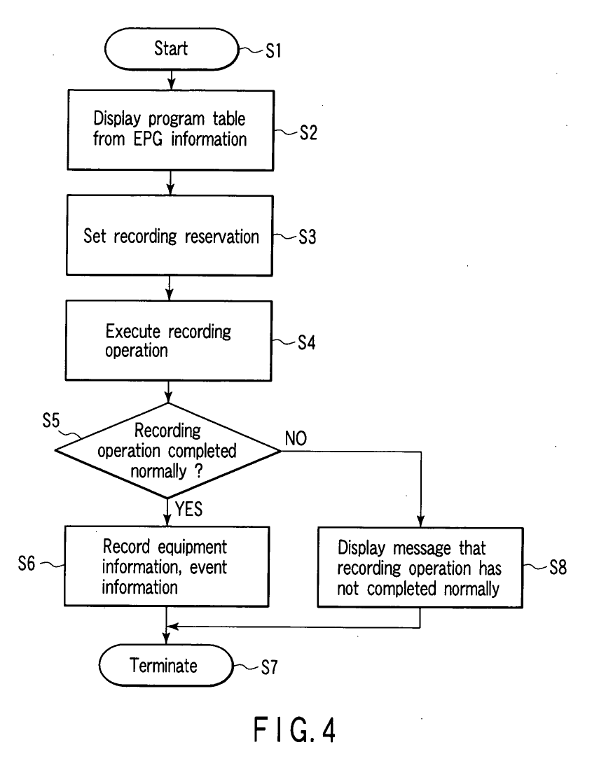

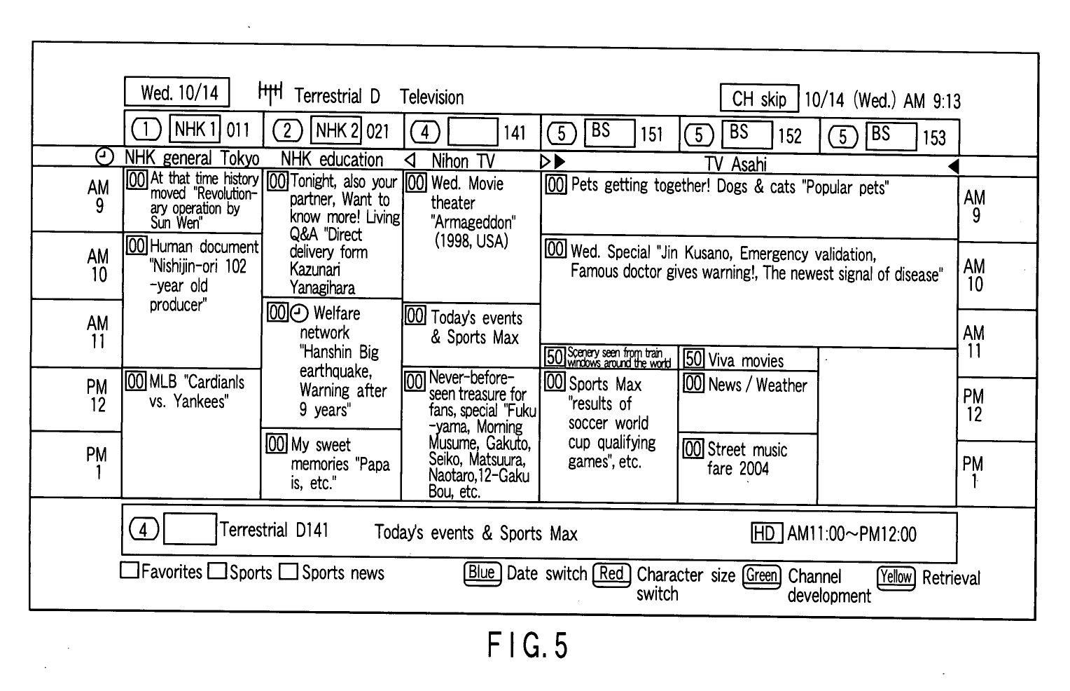

FIG. 4 shows a flowchart for explaining operations of the broadcast receiver 11 to record the program into the digital recording equipment among each of the pieces of recording equipment connected to the terminals 21-24 of the broadcast receiver 11. When processing is started resulting from a request of the recording of the program (step S1), the control unit 56 displays the program table as shown in FIG. 5 on the basis of electronic program guide (EPG) information acquired from the broadcast signal (step 2).

The user then executes recording reservation setting for the desired programs on the basis of the displayed program table (step S3). In this reservation setting, the broadcast receiver 11 selects the program to be recorded and also selects to set the digital recording equipment to which the reservation-set program is recorded on.

The control unit 56 executes a recording operation so as to record the reservation-set program into the reservation-set digital recording equipment when it has reached the preset time for a recording reservation (step S4).

The control unit 56 then determines whether or not the program recording operations have been normally completed, and if it is determined that the operations have completed normally (Yes, in step S5), the broadcast receiver 11 records equipment information (equipment ID, equipment name, shared holder name, etc.) to specify the digital recording equipment which has performed recording and event information (event ID, channel number, title, content explanation, category, recording range, image quality mode, etc.) related to the recorded program into the nonvolatile memory 59 (step S6) and terminates this recording processing (step S7).

If it is determined that the operations have not completed normally (No, in step S5), the control unit 56 displays the massage indicating the fact that the operations have not completed normally onto the video display unit 14 (step S8) and terminates this recording processing (step S7).

According to recording operations described above, the user can arbitrarily select a plurality of sets of digital recording equipment connected to each terminal 21-24 of the broadcast receiver 11 and record programs sequentially.

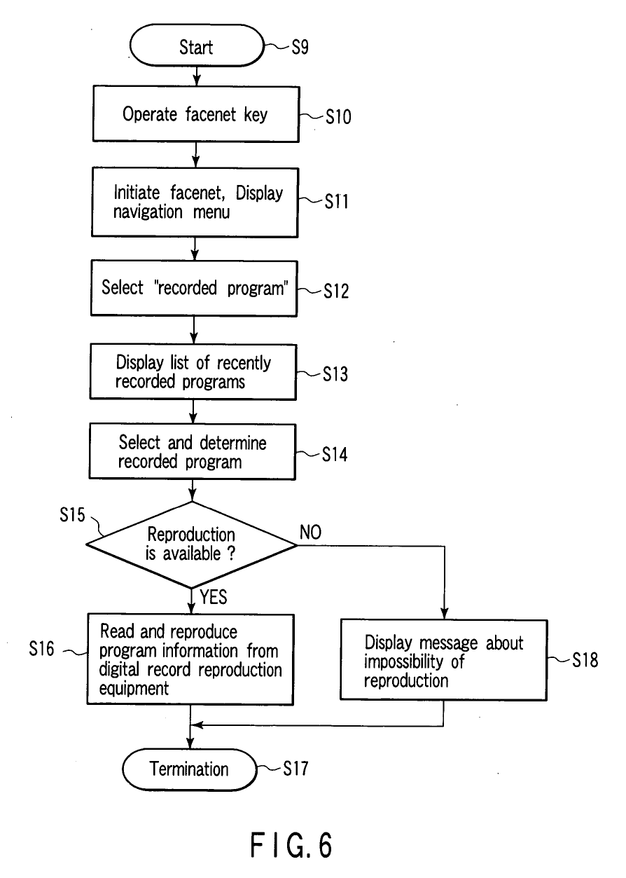

FIG. 6 shows the flowchart for explaining operations to quickly retrieve the desired program and reproduce it among a variety of programs recorded in the plurality of sets of the digital recording equipment as mentioned above. When the processing stars (step S9), the user operates the facenet key 17j on the remote controller 17 (step S10).

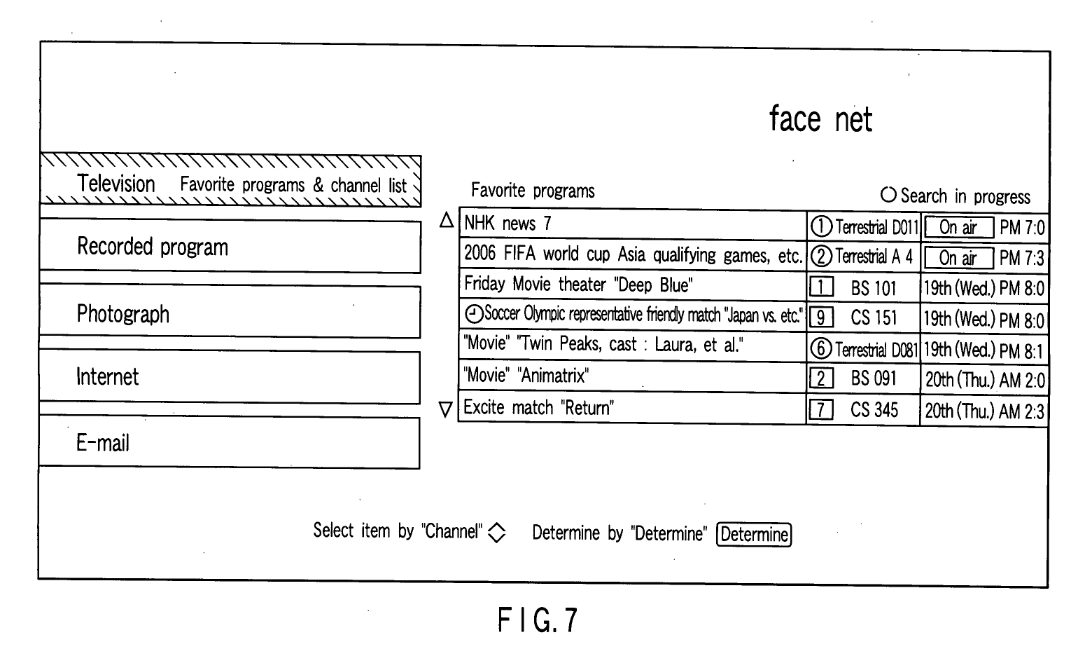

The control unit 56 then starts up the facenet (navigation) and displays the navigation menu as shown in FIG. 7 onto the video display unit 14 (step S11). Five items of “television”, “recorded program”, “photograph”, “Internet” and “E-mail” are selectively provided in this menu. Though the selected items are displayed on a screen in a color different from those of other items, a state in which the item of “television” is selected is indicated by hatching in FIG. 7.

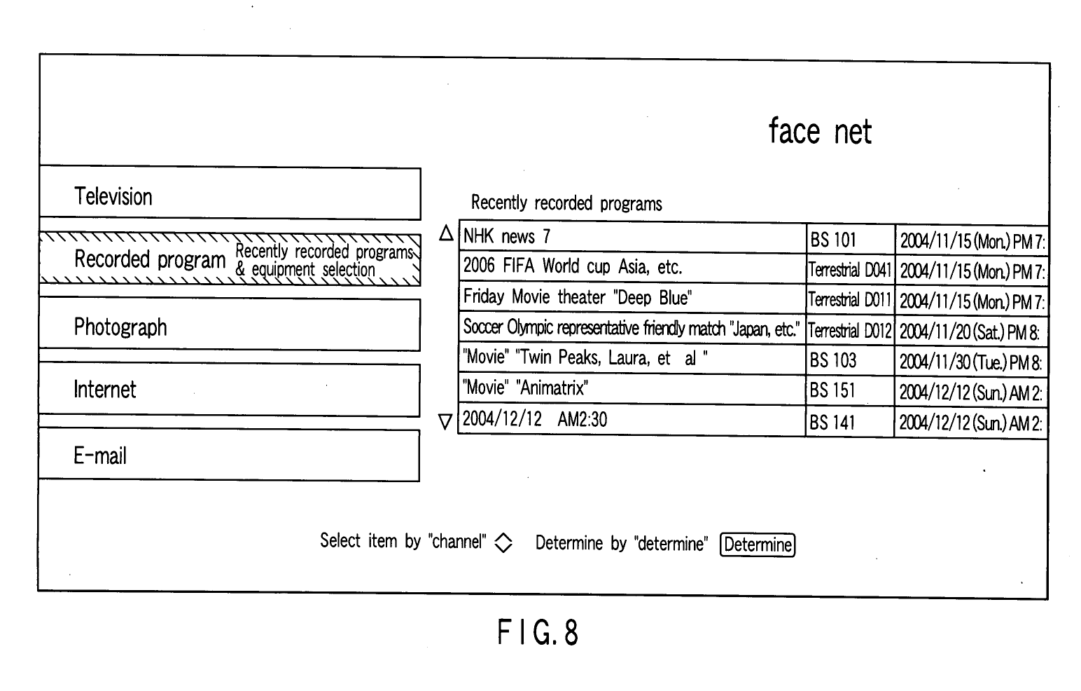

Here, it is assumed that the user operates the cursor key 17f on the remote controller 17 and selects the item of “recording program” (step 12). The control unit 56 then is brought into a state of selection of the item “recording program” as shown in FIG. 8.

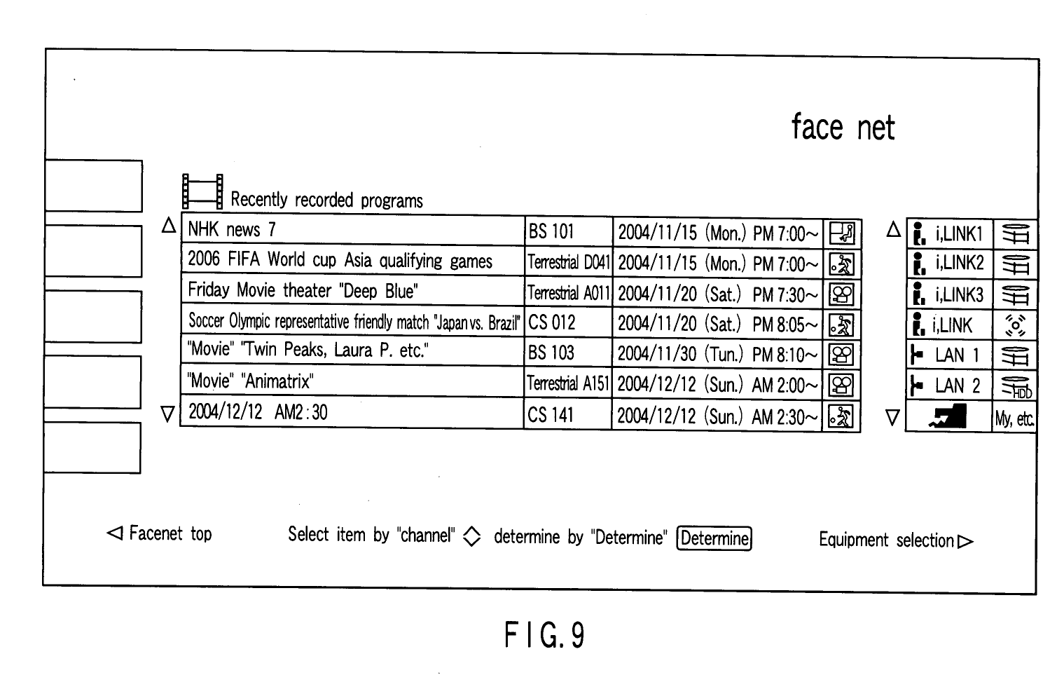

In this state, when the user operates the determination key 17g on the remote controller 17 (step S13), the control unit 56 displays a list of the recently recorded programs onto the video display unit 14 as shown in FIG. 9. In this program list, the title, broadcast channel, recording date, day of the week, time, category, etc. are displayed as information indicating the recorded program.

The list of the recently recorded programs is created by referring to equipment information specifying the digital recording equipment which has recorded and event information in relation to recorded programs recorded on the nonvolatile memory 59 in reservation recording of the programs explained in FIG. 4. In this list, it is possible to display information indicating thirty-five programs at a maximum as far back as the reproduction-requested program recorded therein, regardless of the digital recording equipment with the program recorded therein. Having displayed seven programs in a list form in FIG. 9, the user can see the list of thirty-five programs by operating the cursor key 17f to scroll the display. If the user operates the page switching keys 17i of the remote controller 17, the user can skip, by a single action, the seven programs displayed in the list.

When the user operates the cursor key 17f of the remote controller 17 to select information indicating the desired program from the list of the recently recorded programs and operates the determination key 17g to determine it (step S14), the control unit 56 specifies the digital recording equipment with the selected and determined program recorded therein by referring to the information recorded in the nonvolatile memory 59 and determines whether or not the program is possible to be reproduced (step S15).

This determination conducted by the user determines whether the program can be reproduced or not by comprehensively comparing various conditions in recording and in reproducing, for example, the facts of whether or not the broadcast receiver 11 is connected to the digital recording equipment with the reproduction-requested program recorded therein, whether or not power is tuned on to the digital recording equipment with the reproduction-requested program recorded therein, and whether or not the program is still recorded in the targeted digital recording equipment, etc.

If it is determined that the program can be reproduced (Yes, in step S15), the control unit 56 reads out information about the reproduction-requested program from the targeted digital recording equipment and controls the broadcast receiver 11 to reproduce the program (step S16), then terminates this reproduction processing (step S17).

If it is determined that the program cannot be reproduced (No, in step S15), the control unit 56 displays a message indicating the fact that the requested program cannot be reproduced onto the video display unit 14 and terminates this processing (step S17).

According to the forgoing reproduction operations, the broadcast receiver 11 has a navigation function to display, in a list, the thirty-five recorded programs at a maximum as far back as from the newest recorded program regardless of the digital recording equipment with the desired program recorded therein, so that the user can easily manage the programs recorded in a plurality of sets of digital recording equipment. Accordingly, it becomes possible to quickly retrieve and reproduce the desired program as a result of selection by using the cursor key 17f and determination by using the determination key 17g among programs displayed in a list form.

Considering the increase in the number of connected sets of the digital recording equipment and the recorded programs, it becomes impractical to display in a list all the programs recorded in the plurality of sets of the recording equipment. As the embodiment stated above, it is most practical to cause as least trouble as possible for the user to display a list showing thirty-five programs, at maximum, recently recorded program.

The broadcast receiver 11 can switch the video displayed on the screen of the video display unit 14 on a page basis by operating the page switching keys 17i of the remote controller 17. The cursor key 17f of the remote controller 17 is composed of four keys corresponding to each direction of upward, downward, right, and left so as to move the cursor in directions of up, down, right, and left on the screen.

In other words, for example, if the user operates any of the page switching keys 17i corresponding to the cursor key 17f to move the cursor upward, a current display screen can be switched to the video on the upper side of the display screen. Owing to this page switching function, it becomes possible to select the desired screen in a shorter time than when the user scrolls the screen by operating the cursor key 17f.

Since the page switching keys 17i are disposed in accordance with the cursor key 17f, the moving directions can be easily recognized by the user. The page switching keys 17i can switch such screens of the program table shown in FIG. 5 and of the list of recently recorded programs shown in FIG. 9.

Further, the input switching key 17b on the remote controller 17 is one to switch the video input terminals of the analog system and structured to be selectively operated between “+” side and “−” side. The switching state of the video input terminals is OSD-displayed on the display screen of the video display unit 14.

If the user switches the switching key 17b to the “+” side, the video input terminals are switched in sequence such as VIDEO 1-VIDEO 2-VIDEO 3-VIDEO 4-VIDEO 5—high definition multimedia interface (HDMI)-Broadcast-VIDEO 1. If the user switches the switching key 17b on the “−” side, the video input terminals are switched in a reverse sequence: Broadcast-HDMI-VIDEO 5-VIDEO 4-VIDEO 3-VIDEO 2-VIDEO 1-Broadcast. Conventionally, since the user could only switch the video input terminals in the forward direction, this was an inconvenience to the uses, thus the remote controller 17 can improve the operability by adding the function of switching in the reverse direction.

The video input switching by means of the input switching key 17b adopts a so-called “preceding input system” in which only the OSD display is changed and the screen is changed by bringing the operation into a stop for a prescribed time period in a state that the input switching key 17b is continuously pushed. Accordingly, the unnecessary changing of the screen at every operation of the input switching key 17b is eliminated.

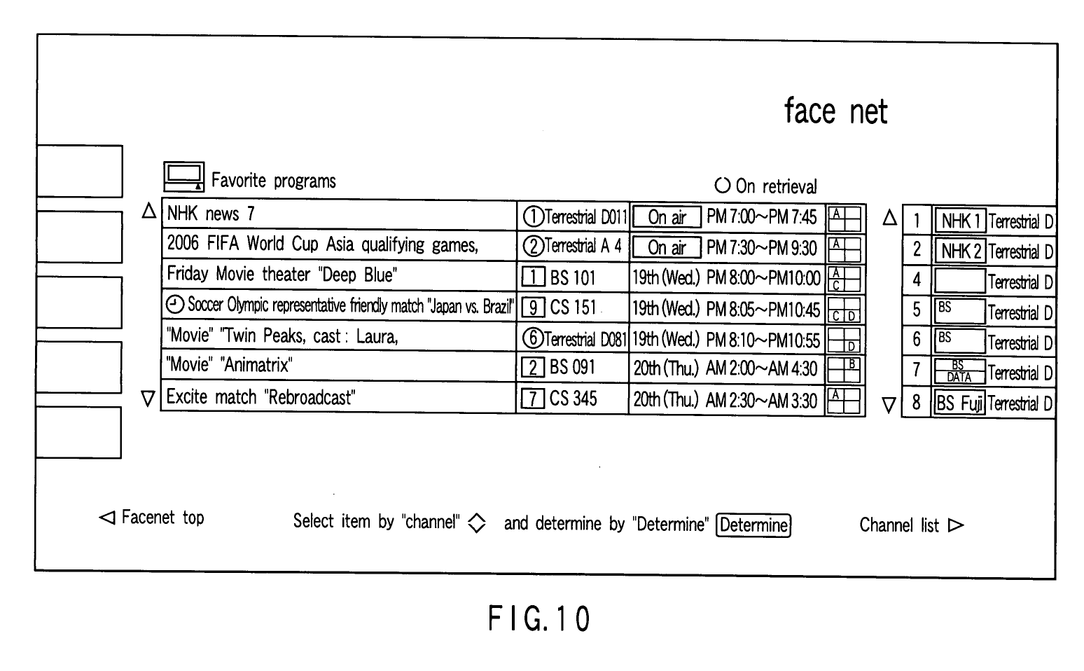

Further, if the user inputs preference information in relation to channels, categories and keywords, the broadcast receiver 11 automatically retrieves the programs corresponding to the preference information up to one week hence from a time point of the input of the preference information and makes a screen display as a favorite program list as shown in FIG. 10. The user can also select a specific program from the favorite program list to set a recording reservation.

This favorite program list is displayed by selecting the “television” items on the navigation menu shown in FIG. 7 by the cursor key 17f and deciding by the determination key 17g. In the retrieval of the favorite programs, the user can set four kinds of combinations, A-D, of the channels, categories and keywords.

A combination A can be set as a combination of, for example, “soccer” as the category, “world” as the keyword and “NHK” as the channel, and a combination B can be set as a combination of, for example, “base ball” as the category, “Japan” as the keyword and Nihon “TV” as the channel. The favorite program list, as shown in the column of the right side in the favorite program list shown in FIG. 10, shows by which combination of A-D each program is retrieved. A plurality of combinations A-D are displayed for the programs with preference information overlapped thereto.

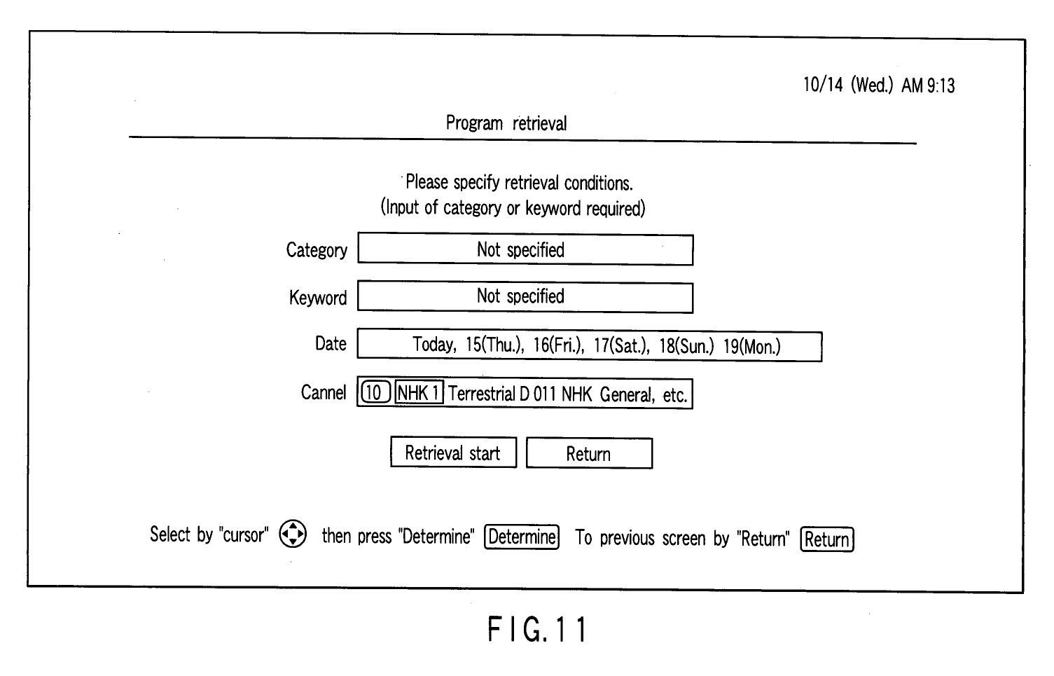

The broadcast receiver 11 operates the yellow key 17m on the remote controller 17 in the display state of the program list shown in FIG. 5, then displays a keyword retrieval screen as shown in FIG. 11. The user inputs four items of the category, keyword, date, and channel onto this keyword retrieval screen, then the user can automatically retrieve the program up to one week hence from the time point of the input of the four items to display the retrieval result in a list form.

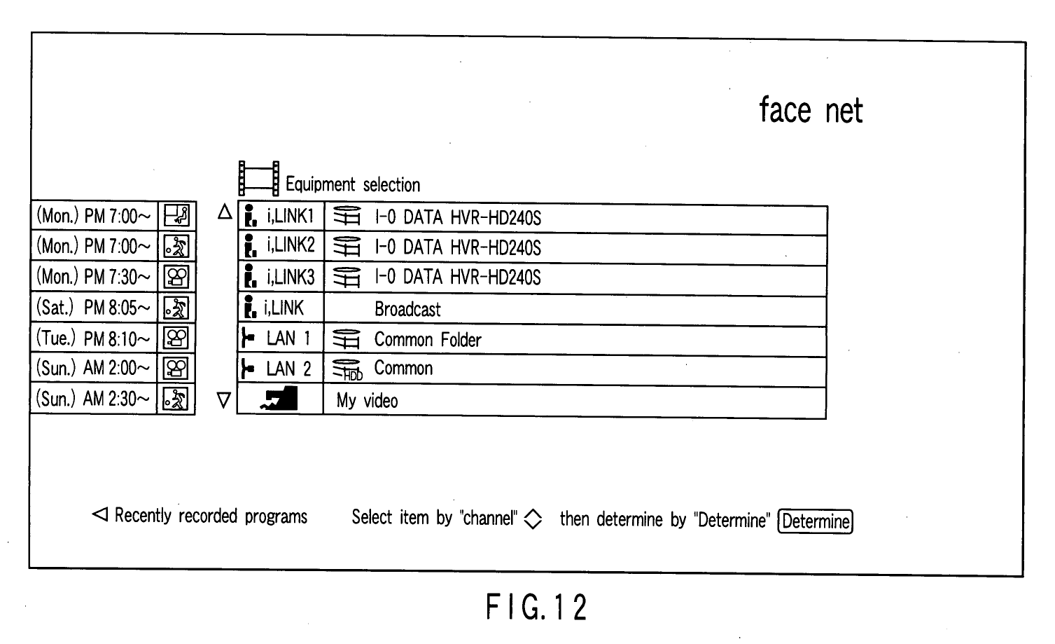

The broadcast receiver 11, as shown in FIG. 12, can display the list screen of the connection equipment by scrolling the screen on the right side of the list table of the recently recorded program shown in FIG. 9. In this list screen of the connection equipment, all the equipment connected to each terminal 21-24 (however, if a broadband router 31 is connected, not all but up to the router 31) can be made in a list display.

On this list in FIG. 12, an icon indicating that the LAN 1 is a LAN compatible HDD dedicated port is attached to the LAN 1 corresponding to the first LAN terminal 21, and an icon indicating that the LAN 2 is a generic LAN compatible port is marked to the LAN 2 corresponding to the second LAN terminal 22.

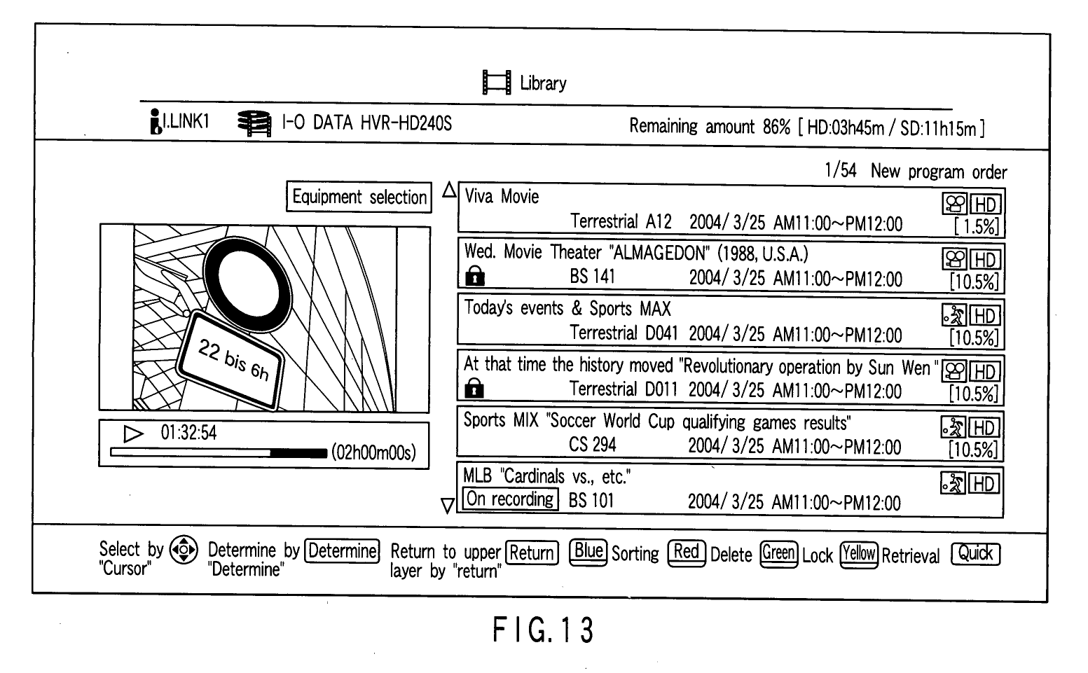

If the user selects the desired digital recording equipment from the display screen of the connection equipment list by the cursor key 17f and determines by the determination key 17g, the list of the programs recorded in the selected and determined digital recording equipment is displayed as a library as shown in FIG. 13.

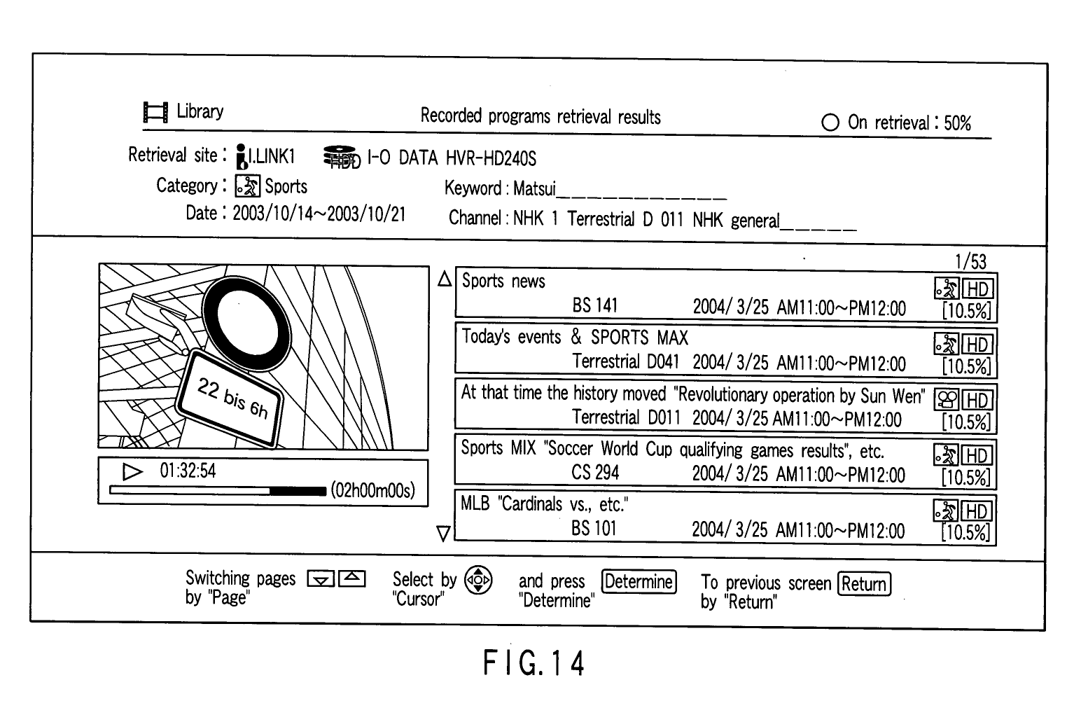

If the user operates the yellow key 17m of the remote controller 17 in the display state of the library screen, the keyword retrieval screen shown in FIG. 11 is displayed. Then, if the user inputs the four items of the category, keyword, date, and channel into the keyword retrieval screen, the programs corresponding to the retrieval conditions are retrieved among the programs recorded in the selected and determined digital recording equipment and displayed in the list form as shown in FIG. 14.

In some cases, in a broadcast receiver with this network connected thereto, first and second digital television broadcast receivers 11, 11′ share a single piece of digital recording equipment (recording means). In this case, the first and second broadcast receivers 11, 11′ can reserve and record the same program. Therefore, these broadcast receivers 11, 11′ are unique in that they do not cause conflict in recording operations. Each receiver 11, 11′ has the connection means (terminals 21-24 and hub 26 in FIG. 1).

Each broadcast receiver 11, 11′ has the equipment selection means for selecting the desired recording means among the plurality of recording means. The selection can be performed from the facenet screen as shown in FIG. 12. When the recording reservation has been made, each broadcast receiver 11, 11′ has the recording signal output means for supplying the recording signal to the desired recording means selected by the equipment selection means to record it. That is, the control unit 56 in FIG. 2 includes the recording signal output means for output of the reproduced recording signal to the desired digital recording equipment.

Here, for managing the recording signal recorded in the desired recording means, each broadcast receiver 11, 11′ also has means for additionally writing, to the management information stored in the desired recording means, the ID information of the receiver main bodies which have already output the recording signals. Each broadcast receiver 11, 11′ further includes means for selecting the desired recording means by the equipment selection means, checking the ID information at the time of overwriting or additional recording and overwriting, or additionally recording the recording signals if the ID information is equal to their own ID information.

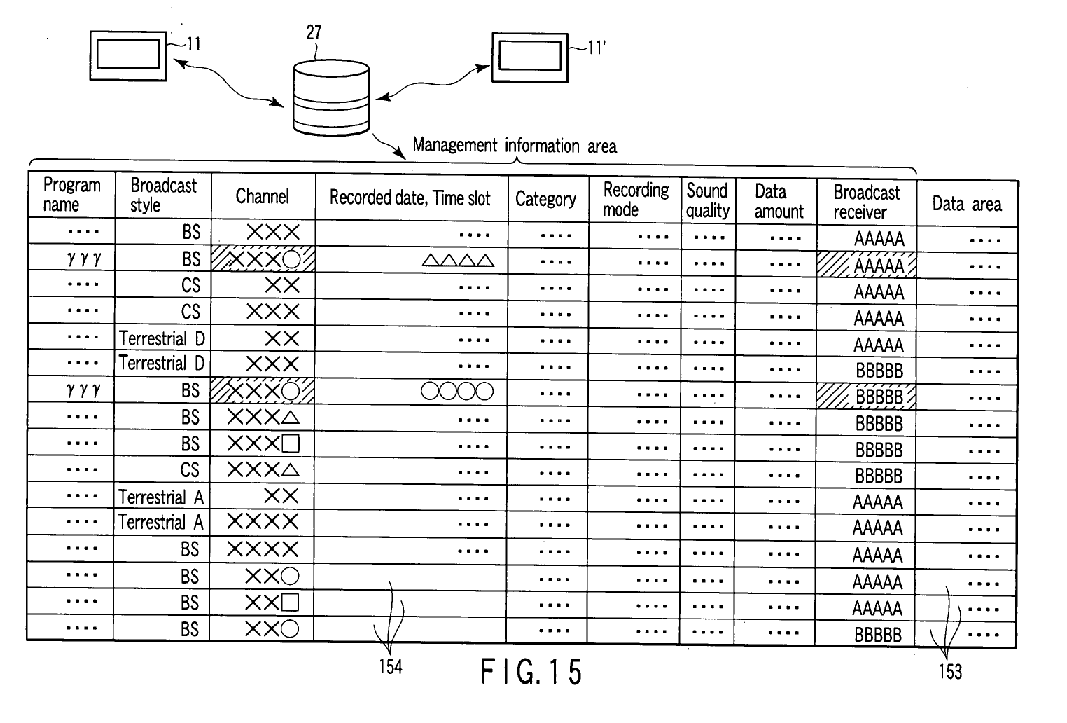

The case that the recording means, for example, the HDD 27 is accessed from the broadcast receivers 11, 11′ will be described below. FIG. 15 shows an example of a format of the management information stored in the HDD 27. The management information includes the name of the recorded program, and the kind [BS broadcast, CS broadcast, terrestrial digital broadcast (terrestrial D), terrestrial analogue broadcast (terrestrial A), a channel, a date of recording, a time zone, a category of a program, a recording mode (high quality HD, standard SD), a sound quality, a data amount (a percentage to the HDD 27), etc. of the broadcast corresponding to the name of the recorded program. That is, the necessary information which is required to display the library shown in FIG. 13 when the HDD 27 is specified.

Furthermore, in this network system in FIG. 1, the HDD 27 especially includes the IDs of the broadcast receivers 11, 11′ in the management information. The information to identify from which broadcast receivers 11, 11′ the recorded programs are taken is recorded in accordance with each name of the programs. In FIG. 15, “AAAAA” indicates an ID code of the broadcast receiver 11 and “BBBBB” is an ID code of the broadcast receiver 11′. Though the management information to manage each program further includes an entry point, etc., of an address of a data area with the corresponding data recorded therein, this is not shown in FIG. 15.

These broadcast receivers 11, 11′ can make recording reservations from the electronic program information shown in FIG. 5. At this time, the broadcast receivers 11, 11′ can secure, in advance, the management area and data area for the digital recording equipment used for recording. In FIG. 15, though the IDs of the broadcast receivers 11, 11′ are shown, some parts of the management information areas and the data area are shown as blank parts 153, 154. These blank parts 153, 154 mean that they are the areas secured by the recording reservations, respectively.

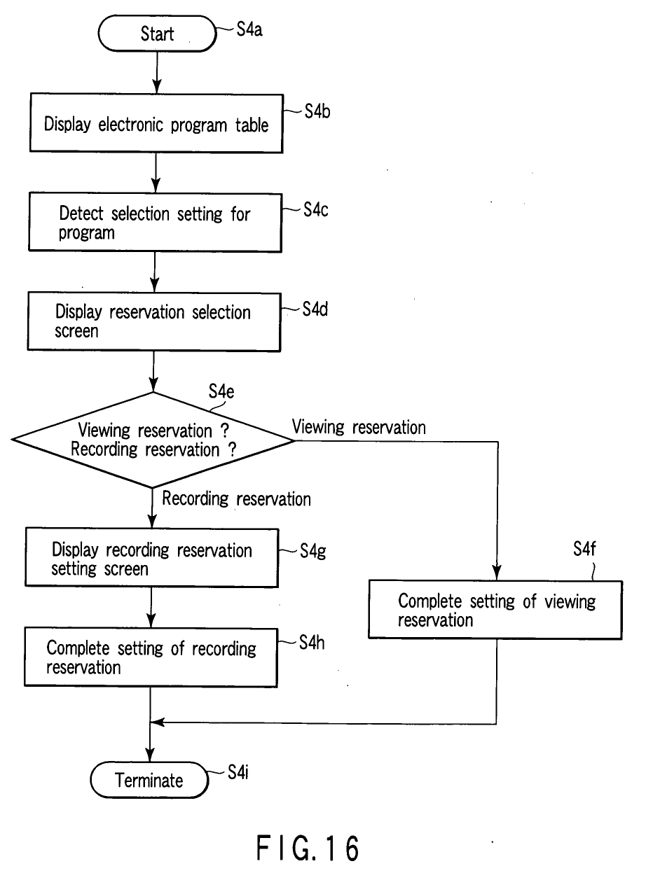

FIG. 16 shows the flowchart for explaining the operations to set the program specifying reservations to the broadcast receivers 11, or 11′. The user starts these operations by operating the program table key 17h of the remote controller 17 (step S4a).

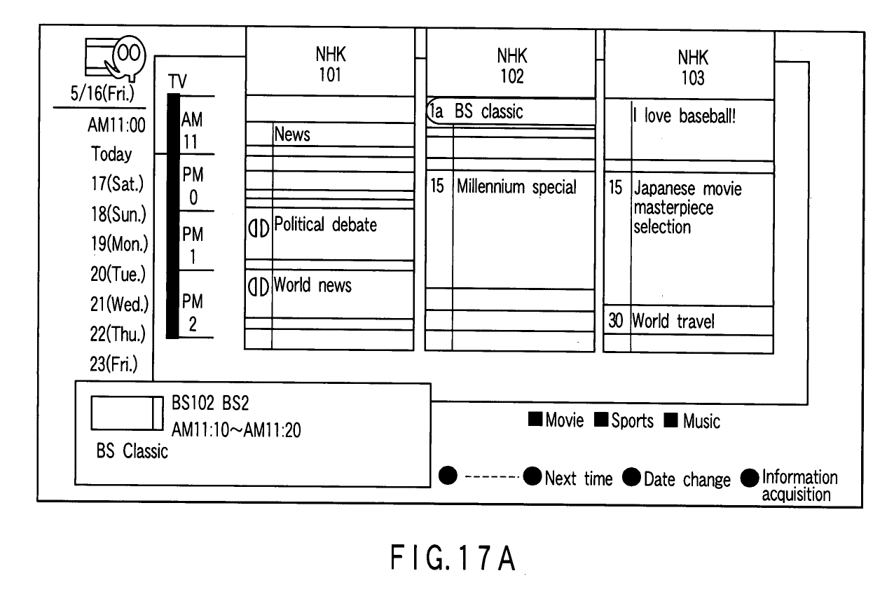

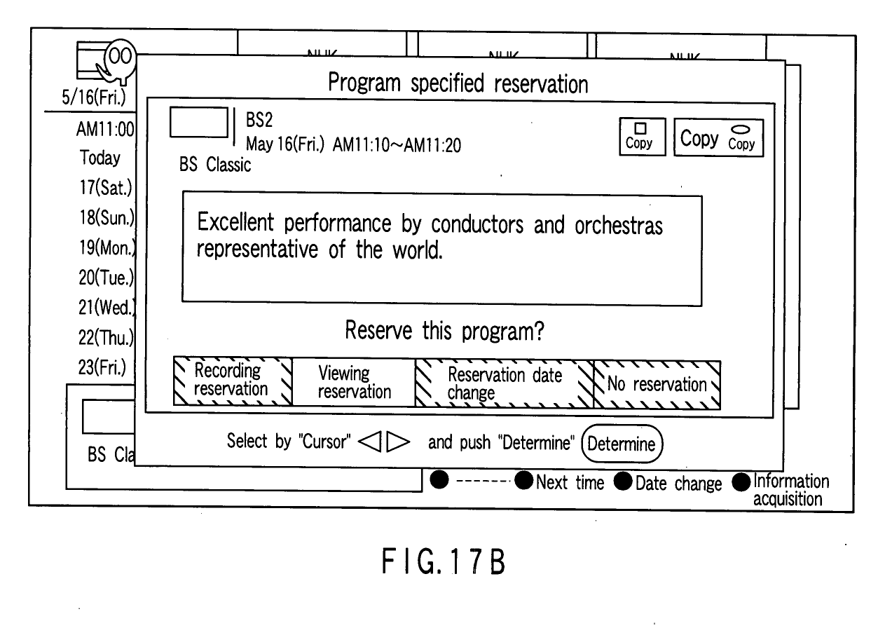

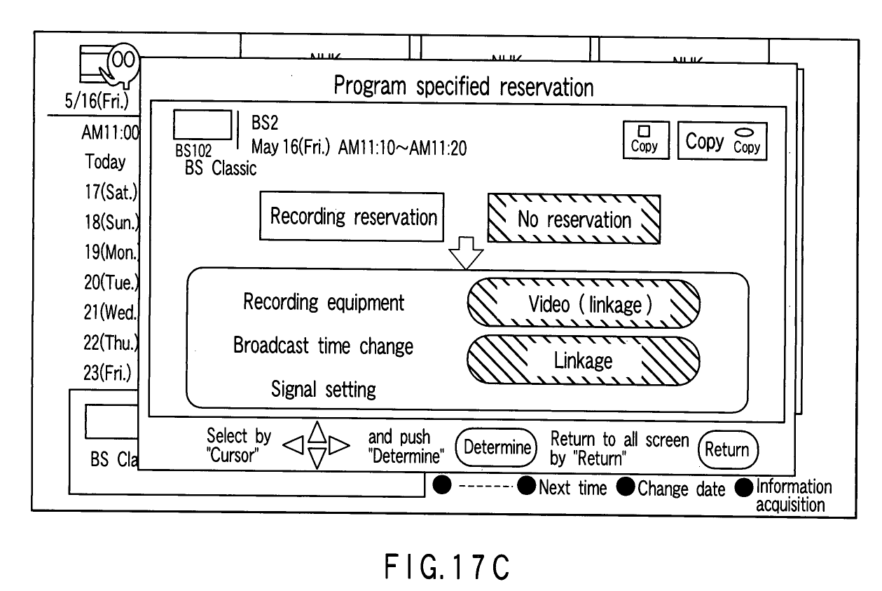

Then, the control unit 56 displays the electronic program table as shown in FIG. 17A on the video display unit 14, based on the electronic program guide (EPG) information acquired from the broadcast signal in advance (step S4b).

Thereby, the user can selectively set the desired programs from the electronic program table. The user selectively sets the desired programs by operating the cursor key 17f and the determination key 17g on the remote controller 17.

Therefore, when detecting the fact of the selective setting of the desired programs from the electronic program table (step S4c), the control unit 56 displays the reservation selecting screen as shown in FIG. 17B (step S4d).

In this reservation selecting screen, the broadcast channels, broadcast dates, rough explanations of the contents, etc. in relation to the previously selected and set program, and the user can select whether the programs are resulted form the recording reservation or only from the viewing reservation. The user can select the recording reservation or viewing reservation by operating the cursor key 17f and the determination key 17g of the controller 17.

The control unit 56 determines which of the recording reservation and the viewing reservation is selected, and when determining that the viewing reservation is selected, the control unit 56 stores each information set for the viewing reservation into the nonvolatile memory 59 (step S4f), then, terminates this reservation setting processing (step S4i). Resulting from the setting of the viewing reservation as described above, the selected program is automatically selected to be supplied for viewing.

When determining that the recording reservation is selected in the step S4e, the control unit 56 displays the recording reservation setting screen shown in FIG. 17C (step S4g). By using this setting screen, the control unit 56 can select whether or not the recording reservation for the previously selected and set program is made and can specify the digital recording equipment or recording medium to be used for recording and the like.

When the recording reservation is made at the setting screen and a variety of necessary items are set thereby, the control unit 56 stores this information into the nonvolatile memory 59 and completes the recording reservation setting (step S4h), then terminates this processing (step S4i). By setting the recording reservation like this, the selected program is automatically recorded in the specified digital recording equipment or the recording medium.

Next, the process up to the recording reservation is made through the program specifying reservation and the recording mode is set through the recording setting screen from the screen of the program specifying reservation will be explained. The following explanation also applies to the recording of the viewing program.

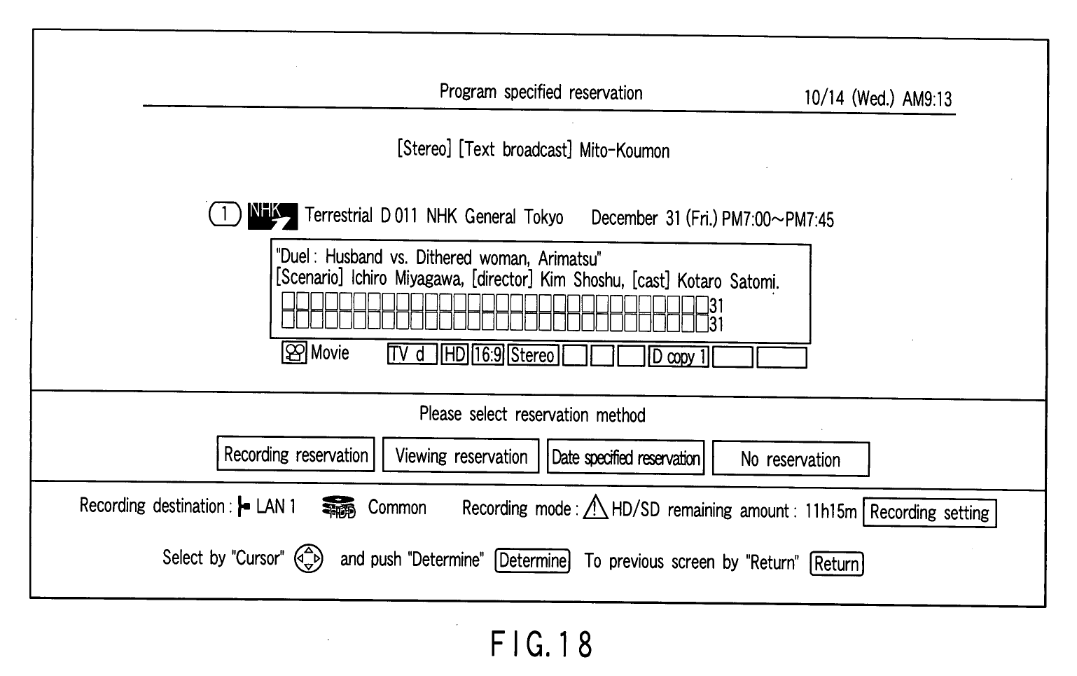

FIG. 18 shows the screen displayed at the time of specifying the program to be recorded from the electronic program table. The kind of broadcast, a broadcast date, a broadcast time, a title of a program, etc. are displayed thereon. A lower area of the screen indicates an area to select a reservation method which was previously explained in FIG. 17A-FIG. 17C.

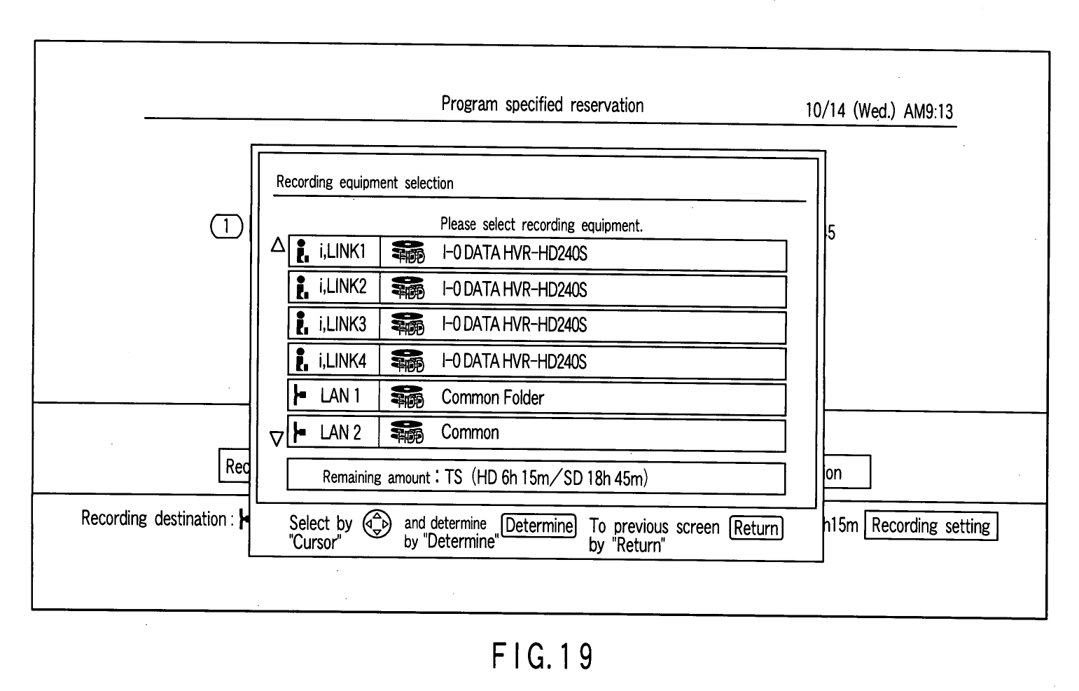

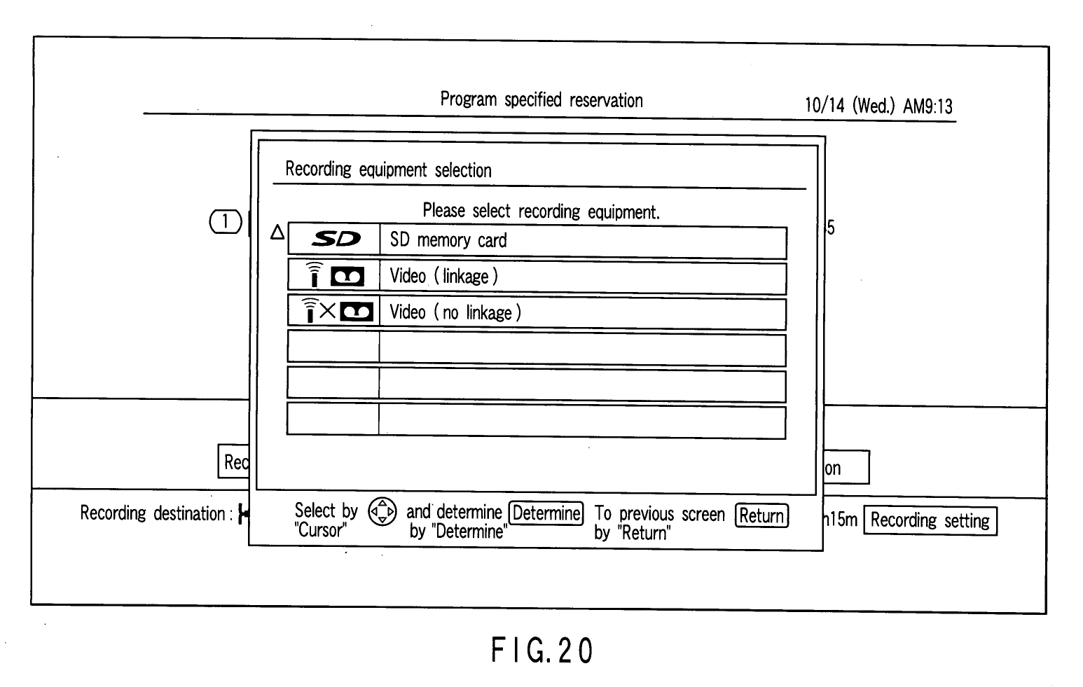

FIG. 19 and FIG. 20 show examples of the equipment selection screens to select the recording equipment. FIG. 20 shows the equipment which could not be displayed in an equipment list table in FIG. 19. By operating the cursor key 17f of the remote controller 17, the selection screens are scrolled and displayed as shown in FIG. 19 and FIG. 20.

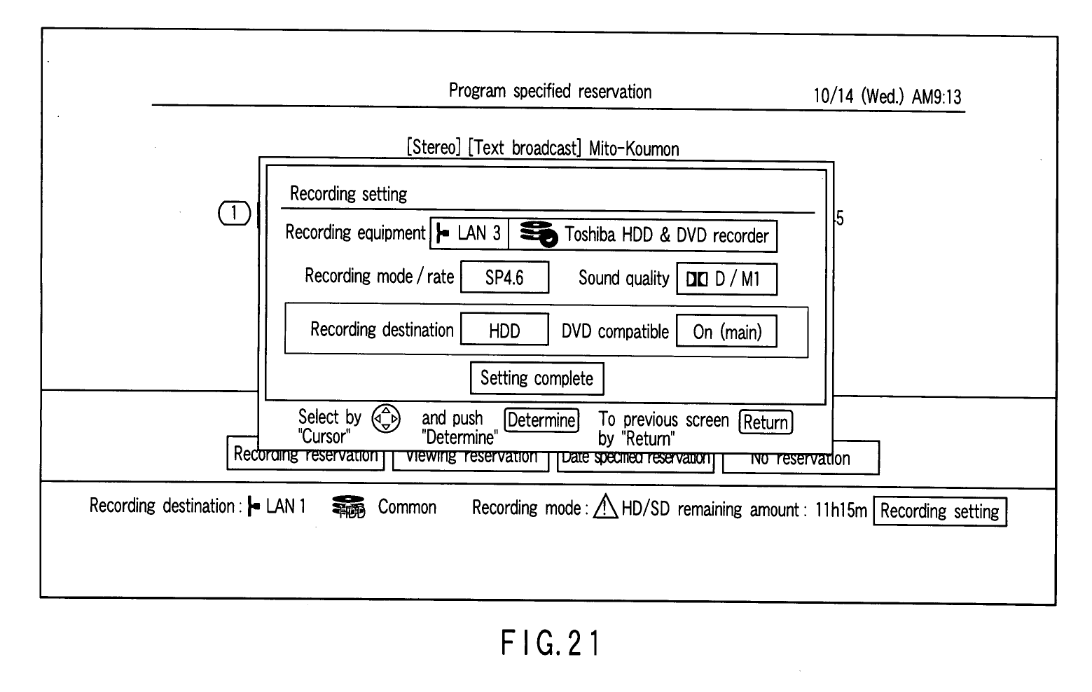

FIG. 21 shows an example of a recording setting screen displayed when the DVD recorder 29 connected to the LAN 3 is selected and the recording reservation button is successively selected. This setting screen indicates the name of the selected recording equipment and the connection state. In the example shown in FIG. 21, the recording equipment and the connection state are the DVD recorder 29 and the LAN 3, respectively. In the example shown in FIG. 21, an SP (meaning recording as down-conversion) is indicated as the recording mode, and then bit rates (4, 6) are displayed concomitantly. As for a sound quality, it is displayed that a dual mode D (main sound+sub sound) and a monaural mode M1 can be selected as a recording processing manner for sound information. The user can set and set either the dual mode D or the monaural mode M1 by the cursor key 17f and the determination key 17g, respectively. In the case of the DVD recorder 29, it has a built-in HDD and both the built-in HDD and the HDD 27 become recording equipment objects; in this case, it is indicated that the HDD 27 is the target recording equipment. If the user selects a button indicating “setting completion” by selecting the cursor key 17f and operates the determination key 17g of the remote controller 17, the setting to the DVD recorder 29 is completed.

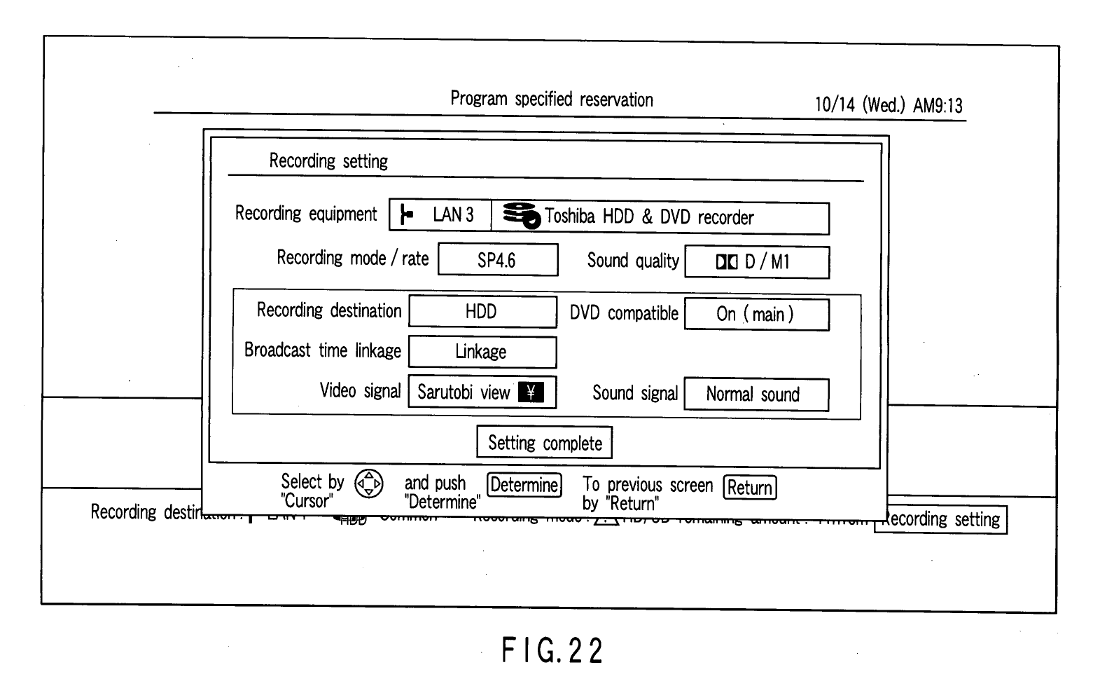

An example in FIG. 22 additionally shows “linking” to the broadcast time period in comparison with the example in FIG. 21. If this contents is sufficient for the user, the user selects the button indicating “setting completion” by the cursor key 17f and operates the determination key 17g of the controller 17, then, the setting for the DVD recorder 29 is completed.

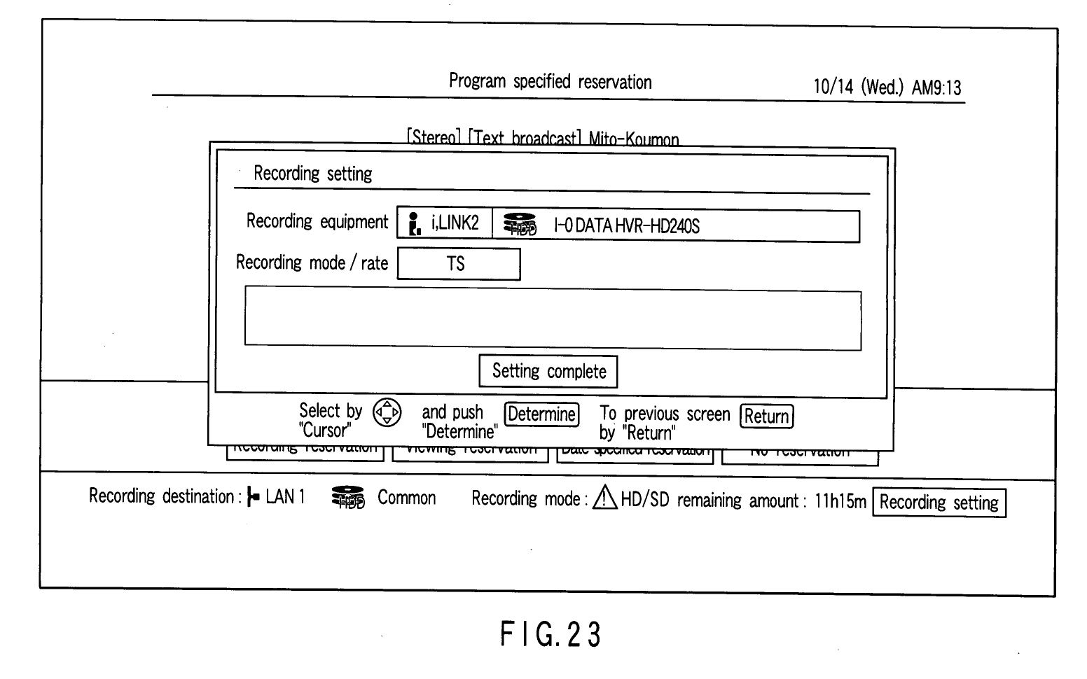

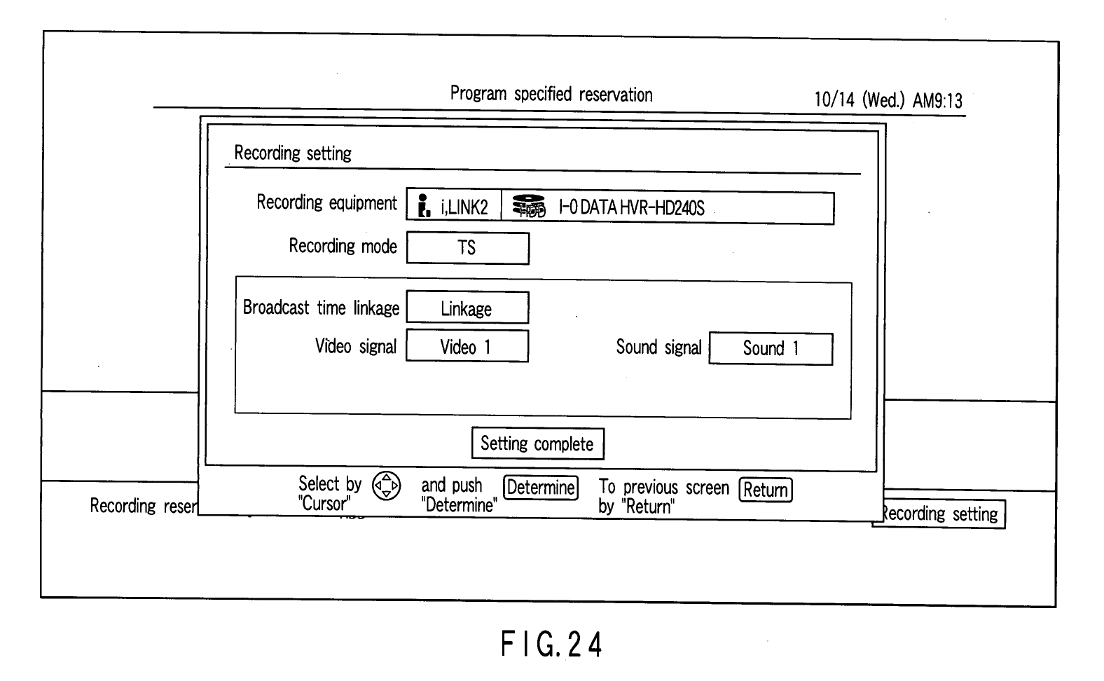

FIG. 23 shows an example of a recording setting screen by which the HDD device (AV-HDD) 41 connected to the i.LINK 2 is selected and a recording reservation button is selected successively in the equipment selecting screen. In this case, the aspect of selection of TS (meaning direct recording of a transport stream) as a recording mode is displayed. FIG. 24 shows the aspect of the specifying to make the recording linked with the broadcast time as for the setting in FIG. 23.

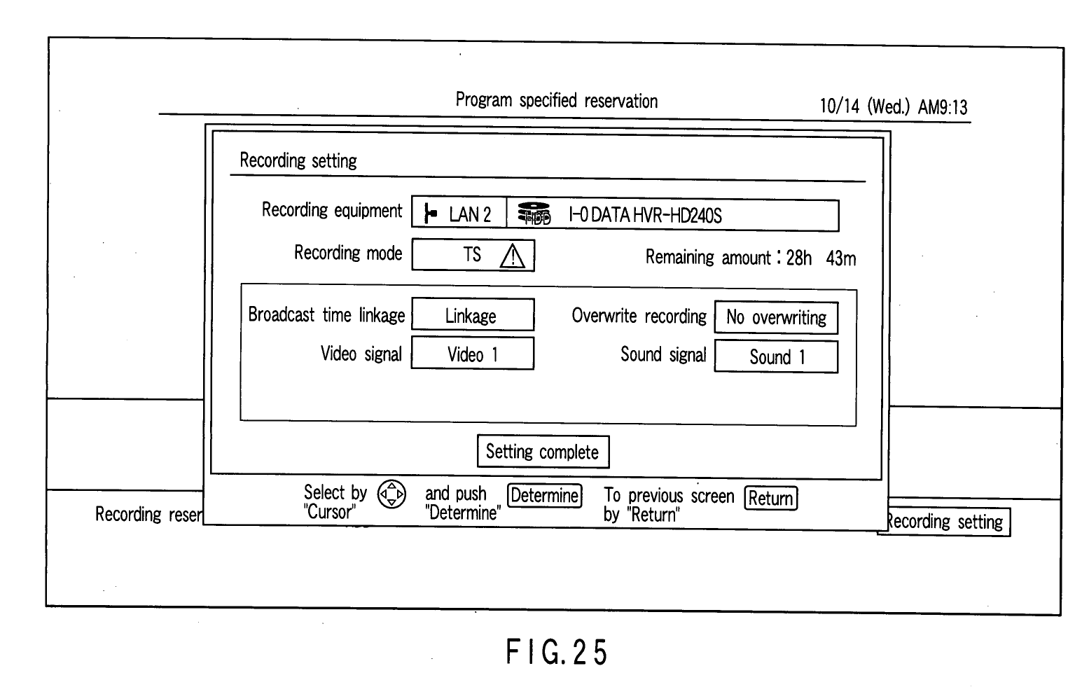

FIG. 25 shows an example of an aspect of a recording setting screen by which the HDD 27 connected to the LAN 2 and the recording reservation button is successively selected. The recording setting screen shows, for example, TP as a recording mode. However a mark “!” is indicated concomitantly. The setting screen specifies that recording is linked with the broadcast time and overwrite recording is not performed.

This mark “!” is a warning that there is a possible lack of storage capacity in the event of recording of the reserved program in the specified recording mode. The broadcast-time period of the reserved program can be known. When the recording equipment is selected, the remaining capacity in the recording equipment is also revealed. If the recording mode is specified, the rough recording capacity needed to record the reserved program can be calculated. Therefore, if calculation of the equation: remaining capacity−(bit rate)×(recording time)=A is executed, it becomes possible to determine that the remaining capacity of a recording medium is sufficient or not.

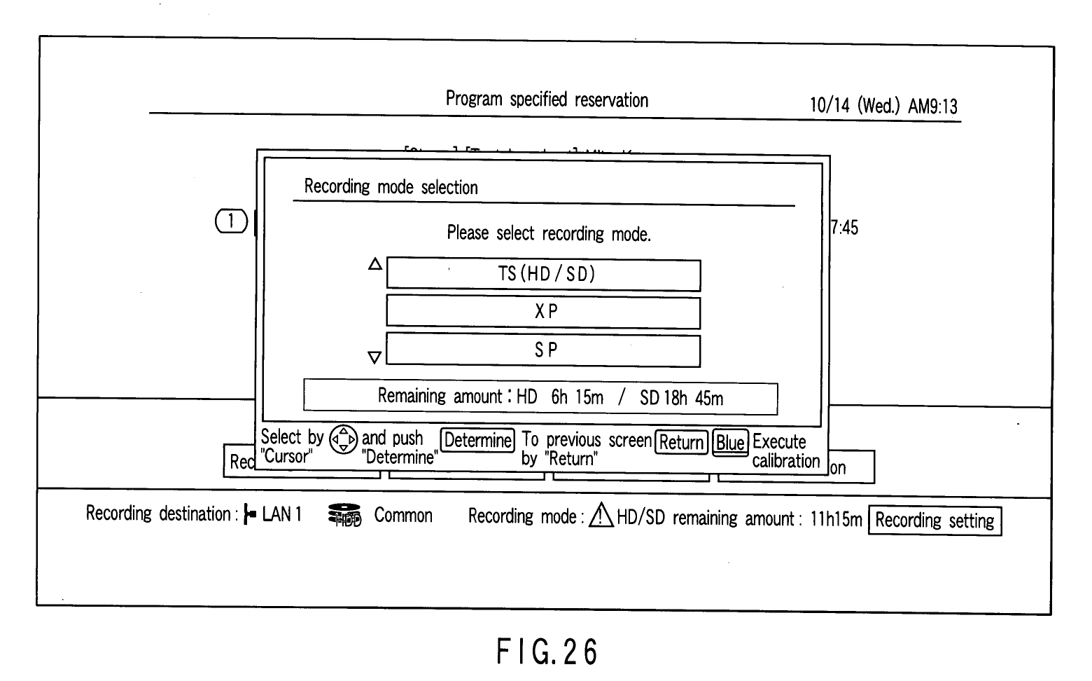

In the event of the indication of the mark “!” as mentioned above, when, for example, the determination key 17f is pushed by putting the cursor on the display unit in the recording mode, a plurality of recording modes TS, XP, and SP are lined up as shown in FIG. 26. It is also possible to display LP, EP, F, N, E, etc. (not shown) by the cursor key 17f. At this time, if the user pushes the determination key 17g again, the recording mode can be specified as shown in FIG. 24 or FIG. 25. However, if the user pushes the determination key 17g again in this recording mode, the display state as shown in FIG. 26 can be displayed again.

The broadcast receiver 11, 11′ can effectively execute calibration by operating the blue key 17m of the remote controller 17 in the state as shown in FIG. 26. This calibration is a simulation function to determine if the recording capacity in the recording equipment is sufficient in the event of the recording of the reserved program onto the selected recording medium, for example, in each indicated recording mode of the TS, XP, and SP. As stated above, the recording condition is set and the management information as explained in FIG. 15 is structured.

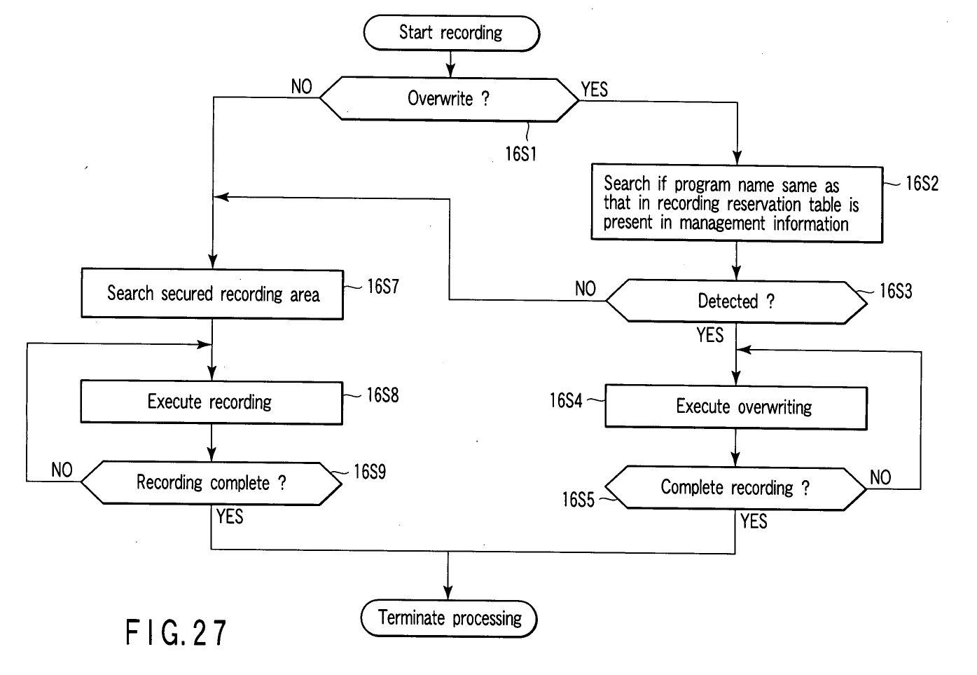

FIG. 27 shows the flowchart of an example of operations in recording. When the recording is started, the control unit 26 in the broadcast receivers 11, 11′ determines if “overwriting” is specified or not. If the event of the specifying of overwriting, the control unit 56 determines the presence of the same name of the program as that of the recording reservation table in the management information (steps 16S1, 16S2). In the event the same name exists, the control unit 56 executes the overwriting in the corresponding area in the recording equipment (steps 16S3, 16S4, 16S5). In the event of specifying no overwriting, the control unit 56 searches for a secured recording area, and when a recording area is detected, the control unit 56 performs recording in the corresponding area (steps 16S7, 16S8, 16S9).

The recording reservation table includes the recording start time information, and the corresponding name of the program is determined at the time of matching between a current time and a recording start time in the recording start time information. Then, the name of the reserved program is checked with the name of the program registered in the management information. Next, the ID information of the recording equipment main body is checked. The order of the checking may be reversed. The reservation table may be stored in a desired recording medium (HDD 27 in the above-mentioned example). The reservation table may also be stored in the memory in the control unit 56 and also stored in both the HDD 27 and the memory.

According to these broadcast receivers 11, 11′, the means for recording the ID of the broadcast receiver main bodies records the ID at the recording reservation and further includes means for securing the areas for recording. The means for recording may include means for recording the recording mode information which is set by the user.

Means for overwriting or additionally recording on the recording medium when the recording is started may include means for checking the ID and also checking the name of the program or the name of the folder reserved for the recording. The means may also include means for checking the recording mode. The checked items are reflected to the control unit 56 for executing appropriate recording. The ID of the broadcast receiver main bodies may prepare MAC_ID+reservation IDs for each recording title.

In the explanation above, though the control unit 56 retrieves all the management information of the recording equipment (HDD 27 in the case of the above-mentioned example) and detects the recording area, the control unit 56 may limit the area to be retrieved only within a specified folder. That is, it takes so long to retrieve the management information in the recording equipment that the control unit 56 may perform the recording setting by specifying a folder as a recording destination instead of a specified recording equipment level. In this case, when the recording is started, the control unit 56 performs two-layered retrieval such as retrieval for registered recording start time information corresponding to the current time and retrieval for a registered folder name. This retrieval step is processed in a step 16S2 shown in FIG. 27. The checking is performed for the names of programs registered in the recording reservation table and the names of programs managed in the management information in the digital recording equipment. The checking may be performed not only for the names of programs but also for the recording start time information.

In the case of performing overwrite recording, the preceding recorded title may be deleted. In this case, when the recording title to be deleted is retrieved, the following conditions should be given. The conditions are, for example, the folder name to specify the retrieval range, and the MAC_ID to individually identify the broadcast receivers 11, 11′. Further, a reservation ID and reference data information (for setting recording titles of past programs as compared with reference data as targets to be recorded) to identify reservation units in relation to the recording titles may be added. In other words, the management information in the recording medium includes the above-mentioned information, and the recording reservation information table of broadcast receivers 11, 11′ respectively includes the above-mentioned folder name, reservation ID, reference date information (information about date on which recording is performed).

As described above, in the embodiment of the present invention, each broadcast receiver has a tuner unit for receiving broadcast signals, a signal processor for reproducing the signal from the tuner unit, a connecting unit to which the plurality of sets of recording equipment are connectable via the network, and a control unit for integrating the operations thereof. Each broadcast receiver can select the desired recording device among the plurality of sets of recording equipment on the basis of the control by means of the control unit, and record the information onto the recording medium in the recording equipment. When supplying the recording signal to the desired recording device on the basis of the control by the control unit 56, and when the desired recording device stores the recording image signal and its management information, each broadcast receiver adds the ID information of the broadcast receiver main body which has already output the recording signal.

The recording signal control unit 56c checks the ID attached to the recording area of the corresponding information at overwriting or additional recording of the information, and if the ID is the same as its own ID, then the control unit 56c can perform the overwriting or additional recording.

The control unit 56c checks the ID attached to the recording area of the corresponding information upon overwriting or additional recording of information onto the recording medium of the desired recording device, and if the ID is different from its own ID, then, the control unit 56c can secure a new recording area to record the information therein.

The management information also includes the recording reservation information, and the ID information control unit 56a adds the ID information to the management information of the recording equipment when the recording is reserved and recording equipment is specified by the broadcast receiver main body.

The ID information control unit 56a adds the ID information to the management information of the recording equipment when the recording is reserved, and secures the area to record onto the recording medium in the desired recording equipment.

The ID information control unit 56a adds the ID information to the management information, secures the area to record onto the recording medium in the desired recording equipment, and adds the setting recording mode information to the management information.

A control unit included in the recording signal control unit 56c for designating overwrite recording and additional recording checks the ID information, the names of the reserved program and folder and utilizes the result of the checking.

Means included in the recording signal control unit 56c for designating the overwriting and additional recording checks the ID information, checks the names of the reserved program and folder, and checks the recording mode and utilizes the result of the checking. The means for designating the overwriting and additional recording further checks the reservation ID information to identify the reservation units and reference data information for the recording titles that are in the past compared with the reference data.

It is our intention that the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be eliminated from the whole of the constituent elements shown in the embodiments mentioned above. Further, the constituent elements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast receiver to be connected through a network comprising:
connecting units configured to connect a plurality of sets of recording equipment through the network;
an equipment selecting unit for selecting desired recording equipment among the plurality of sets of the recording equipment;
a recording signal control unit configured to supply a recording signal to the desired recording equipment; and,
an identification information control unit configured to add identification information of an recording equipment main body which has output the recording signal, to management information when the desired recording equipment stores the recording signal and the management information.

2. The broadcast receiver to be connected through the network according to claim 1, wherein the recording signal control unit includes a control unit for checking the identification information attached to a recording area of information when performing overwrite recording or additional recording of the information and designating the overwrite recording or additional recording if the identification information is the same as its own identification information.

3. The broadcast receiver to be connected through the network according to claim 1, wherein the recording signal control unit includes a control unit for checking the identification information attached to a recording area of information when performing overwrite recording or additional recording of the information and securing a new recording area to record information if the identification information is different from its own identification information.

4. The broadcast receiver to be connected through the network according to claim 1, wherein the management information includes recording reservation information, and identification information control unit includes means for adding the identification information to the management information of the recording equipment when a recording reservation is made and the recording equipment is specified by the main body.

5. The broadcast receiver to be connected through the network according to claim 1, wherein the identification information control unit adds the identification information to the management information of the recording equipment and further secures an area to record the recording signal onto the recording medium of the desired recording equipment when a recording reservation is made.

6. The broadcast receiver to be connected through the network according to claim 1, wherein the identification information control unit includes means for adding the identification information to the management information of the recording equipment, securing an area to record the recording signal onto the recording medium of the desired recording equipment and also adding set recording mode information to the management information when a recording reservation is made.

7. The broadcast receiver to be connected through the network according to claim 2, wherein the control unit included in the recording signal control unit and designating the overwrite recording or additional recording includes means for checking a name of a program or a name of a folder with the recording reservation made therefore.

8. The broadcast receiver to be connected through the network according to claim 2, wherein a means included in the recording signal control unit and designating the overwrite recording or additional recording includes means for checking the identification information, checking a name of a program or a name of a folder with the recording reservation made therefore and checking a recording mode.

9. The broadcast receiver to be connected through the network according to claim 2, wherein a means included in the recording signal control unit and designating the overwrite recording or additional recording includes means for checking reservation identification to identify reservation units in relation to recording titles and reference date information for setting recording titles that are in the past as compared with a reference date as targets to be recorded.

10. A broadcast receiving method to be used for connection over a network, which includes a tuner unit for receiving a broadcast signal; a signal processor for reproducing the signal from the tuner unit; connecting units to which a plurality of sets of recording equipment can be connected; and a control unit for integrating operations and selects desired recording equipment among the plurality of sets of the recording equipment on the basis of control by the control unit to designate recording of information onto a recording medium of the selected recording equipment, wherein the method comprises:
supplying a recording signal to the selected recording equipment on the basis of the control by the control unit; and
adding identification information of a broadcast receiver main body which has output the recording signal to management information when the selected recording equipment stores the recording signal and the management information.

11. The broadcast receiving method according to claim 10, wherein a recording signal control unit checks the identification information attached to a recording area of information when the information is overwritten or additionally recorded onto the recording medium of the desired recording equipment and designates overwrite recording or additional recording if the identification information is the same as that of the broadcast receiver main body.

12. The broadcast receiving method according to claim 10, wherein a recording signal control unit checks the identification information attached to a recording area of the information when the information is overwritten or additionally recorded onto the recording medium of the desired recording equipment and secures a new recording area to record the information if the identification information is different from that of the broadcast receiver main body.

13. The broadcast receiving method according to claim 10, wherein the management information also includes recording reservation information, and
an identification information control unit adds the identification information to the management information of the recording equipment when a recording reservation is made and the recording equipment is specified by the broadcast receiver main body.

14. The broadcast receiving method according to claim 10, wherein a identification information control unit adds the identification information to the management information of the recording equipment and further secures an area to record the recording signal onto the recording medium of the desired recording equipment when a recording reservation is made from the broadcast receiver main body.

15. The broadcast receiving method according to claim 10, wherein an identification information control unit comprises:
adding the identification information to the management information of the recording equipment;
securing an area to record the recording signal onto the recording medium of the desired recording equipment; and
adding set recording mode to the management information when a recording reservation is made from the broadcast receiver main body.

16. The broadcast receiving method according to claim 11, wherein a control unit included in the recording signal control unit and designating the overwrite recording or additional recording performs:
checking the identification information;
checking a name of a program or a name of a folder with the recording reservation made therefore; and
utilizing a result of checking.

17. The broadcast receiving method according to claim 11, wherein means included in the recording signal control unit and designating the overwrite recording or additional recording performs:
checking the identification information;
checking a name of a program or a name of a folder with the recording reservation made therefore; and
utilizing a result of checking.

18. The broadcast receiving method according to claim 11, wherein means included in the recording signal control unit and designating the overwrite recording or additional recording further checks reservation identification information for bringing recording titles that are in the past as compared with a reference date in relation to recording titles into targets to be recorded.
